(19) United States
(12) Patent Application Publication
(10) Pub. No.: US 2024/0056960 A1
(43) Pub. Date: Feb. 15, 2024

(54) ACTIVATION OF SECONDARY CELLS IN A NEW RADIO FREQUENCY RANGE

(71) Applicant: Telefonaktiebolaget LM Ericsson (publ), Stockholm (SE)

(72) Inventors: Joakim AXMON, LIMHAMN (SE); Muhammad Ali KAZMI, SUNDBYBERG (SE); Iana SIOMINA, TÄBY (SE); Christopher CALLENDER, KINROSS (GB)

(21) Appl. No.: 17/766,230

(22) PCT Filed: Oct. 2, 2020
(86) PCT No.: PCT/EP2020/077710

§ 371 Date: Apr. 2, 2022

Related U.S. Application Data
(60) Provisional application No. 62/910,710, filed on Oct. 4, 2019.

(51) Int. Cl. H04W 48/20; H04B 17/318

(52) U.S. Cl. CPC H04W 48/20; H04B 17/328

(57) ABSTRACT

A User Equipment, UE, in a wireless communication network receives, from a network node, a signal to activate a plurality of secondary cells, SCells. Responsive to receiving the signal, the UE uses a temporal characteristic and a spatial characteristic of a reference cell, selected from the plurality of SCells, to activate the reference cell and at least one other of the SCells in parallel.

### RELATED APPLICATIONS

This application claims priority to U.S. Application No. 62/910,710, filed 4 Oct. 2019, the entire disclosure of which is incorporated by reference herein.

### TECHNICAL FIELD

The present disclosure generally relates to the technical field of wireless communication networks, and more particularly relates to activating secondary cells in Frequency Range 2 (FR2) of New Radio (NR).

### BACKGROUND

In wireless communication networks, carrier aggregation (CA) involves combining the use of more than one carrier, e.g., to increase the bandwidth available to a User Equipment (UE) from one or more base stations. Traditionally, when multiple cells are used for CA, one of the cells is a Primary Cell (PCell), and any others are generally Secondary Cells (SCells). Because the benefits of the SCells are not always required, a UE is able to deactivate an SCell, e.g., to save battery. Should the benefit of an SCell subsequently become advantageous, the UE can activate one or more of any SCells that may be known to the UE. Additionally or alternatively, the base station may send, to the UE, a signal to activate an SCell. For example, the signal may carry a Radio Resource Control (RRC) or Media Access Control (MAC) command that the UE may use to activate the one or more SCells.

The direct activation of multiple SCells is traditionally performed by multiple individual activations performed sequentially, which takes time. The activation also consumes processing resources, which are often provided by designated hardware in order to timely be completed. Traditionally (e.g., as performed in Long Term Evolution (LTE) networks), the costs associated with performing sequential activation of multiple SCells has been tolerated. However, such an approach may be less suitable when applied to more modern technologies, such as NR.

### SUMMARY

Embodiments of the present disclosure enable quick and/or efficient activation of SCells, e.g., in NR FR2. Embodiments of the present disclosure include one or more methods, devices (e.g., UE, base station), systems, computer programs (e.g., comprising instructions which, when executed on processing circuitry of a node, cause the node to carry out any of the methods described herein), and/or carriers containing such a computer program (e.g., an electronic signal, optical signal, radio signal, or computer readable storage medium).

In particular, embodiments of the present disclosure include a method of parallel SCell activation implemented by a UE in a wireless communication network. The method comprises receiving, from a network node, a signal to activate a plurality of SCells. The method further comprises, responsive to receiving the signal, using a temporal characteristic and a spatial characteristic of a reference cell, selected from the plurality of SCells, to activate the reference cell and at least one other of the SCells in parallel.

In some embodiments, using the spatial characteristic of the reference cell comprises using a receiving beam steered in a same direction suitable for receiving the reference cell to monitor for a synchronization signal of the at least one other of the SCells being activated in parallel.

In some embodiments, using the temporal characteristic of the reference cell comprises, locating a frame timing of the other of the SCells being activated in parallel based on a threshold uncertainty interval relative to a timing of the reference cell.

In some embodiments, the method further comprises selecting the reference cell from the plurality of SCells based on the reference cell having a cell condition that is known to the UE.

In some embodiments, the method further comprises selecting the reference cell from the plurality of SCells based on the reference cell being configured with L1-RSRP reporting and an active TCI state not being provided at the time of receiving the signal to activate the plurality of SCells.

In some embodiments, the method further comprises selecting the reference cell from the plurality of SCells based on an SSB measurement time configuration (SMTC) period.

In some embodiments, the method further comprises selecting the reference cell from the plurality of SCells based on an order of the plurality of SCells indicated by the signal to activate the plurality of SCells.

In some embodiments, the method further comprises selecting the reference cell from the plurality of SCells based on a measurement cycle length.

In some embodiments, the method further comprises selecting the reference cell from the plurality of SCells based on a discontinuous reception (DRX) cycle length.

In some embodiments, the method further comprises selecting the reference cell from the plurality of SCells based on a Carrier Specific Scaling Factor.

In some embodiments, the method further comprises selecting the reference cell from the plurality of SCells based on a cell detection duration.

In some embodiments, the method further comprises receiving an indication from the network node of which of the plurality of SCells to use as the reference cell, and selecting the SCell indicated by the network node as the reference cell in response.

In some embodiments, the method further comprises using a Synchronization Signal and Physical Broadcast Channel Block (SSB) of the reference cell to activate the SCells in parallel.

In some embodiments, the method further comprises verifying successful reception of the SCells activated in parallel. In some such embodiments, verifying successful reception of the SCells activated in parallel comprises verifying that a secondary synchronization signal received in an SS-block matches an expected physical cell ID of at least one of the SCells activated in parallel. Verifying successful reception of the SCells activated in parallel may, in some embodiments, additionally or alternatively comprise measuring synchronization signal reference signal received power (SS-RSRP) of an SCell using a single measurement or a plurality of abbreviated measurements, and determining that the SS-RSRP is above a threshold. Verifying successful reception of the SCells activated in parallel may, in some embodiments, additionally or alternatively comprise measuring Layer 1 RSRP (L1-RSRP) of a SSB for an SCell and determining that the L1-RSRP is above a threshold. Verifying successful reception of the SCells activated in parallel may, in some embodiments, additionally or alternatively comprise measuring L1-RSRP of a Channel State Information Reference Signal (CSI-RS) for an SCell and determining that the L1-RSRP is above a threshold. In at least some such embodiments, the threshold is based on a corresponding measurement of the reference cell.

In some embodiments, the method further comprises assigning each of the plurality of SCells to either a first activation group or a second activation group, and commencing activation of each of the SCells in the first activation group before commencing activation of each of the SCells in the second activation group. In some such embodiments, commencing activation of each of the SCells in the first activation group before commencing activation of each of the SCells in the second activation group comprises commencing activation of each of the SCells in the second activation group before all of the SCells in the first activation group have completed activation. Commencing activation of each of the SCells in the second activation group is also responsive to determining, for each of the SCells in the first activation group, a receiving beam, frame timing, and TCI state. In some such embodiments, assigning each of the plurality of SCells to either the first activation group or the second activation group comprises assigning at least two of the SCells to be activated in parallel to the first activation group. In some such embodiments, assigning each of the plurality of SCells to either the first activation group or the second activation group comprises assigning at least two other SCells to be activated in parallel to the second activation group. In some embodiments, assigning each of the plurality of SCells to either the first activation group or the second activation group comprises assigning at least two of the SCells to be activated in parallel to the second activation group. In some embodiments, assigning each of the plurality of SCells to either the first activation group or the second activation group comprises assigning exactly one SCell to the first activation group. Further, commencing activation of each of the SCells in the first activation group before commencing activation of each of the SCells in the second activation group comprises commencing activation of each of the SCells in the second activation group after reporting a valid Channel Quality Indicator (CQI) for the SCell in the first activation group to the network node.

In some embodiments, the method further comprises locating respective synchronization signals for at least two additional SCells based on respective SSBs received from the network node in a same SSB burst. In such embodiments, the method further comprises activating the at least two additional SCells in parallel within a first frequency range using the synchronization signals located based on the respective SSBs. Using the temporal characteristic and the spatial characteristic of the reference cell to activate the SCells in parallel comprises activating the SCells in parallel within a second frequency range disjoint from the first frequency range.

In some embodiments, the method further comprises activating, from a set of the SCells, a maximum number of SCells the UE is capable of activating in parallel, and activating a set of remainder SCells from the set of SCells after activating the maximum number of SCells in the set.

Other embodiments of the present disclosure include a UE in a wireless communication network. The UE is configured to receive, from a network node, a signal to activate a plurality of SCells. The UE is further configured to, responsive to receiving the signal, use a temporal characteristic and a spatial characteristic of a reference cell to activate at least two of the SCells in parallel.

In some embodiments, the UE is further configured to perform any one of the methods described above.

In some embodiments, the UE comprises a processor and a memory. The memory contains instructions executable by the processor whereby the UE is operative in accordance with any of the above.

Other embodiments include a computer program, comprising instructions which, when executed on processing circuitry of a UE, cause the processing circuitry to carry out any one of the methods described above.

Yet other embodiments include a carrier containing the computer program described above. The carrier is one of an electronic signal, optical signal, radio signal, or computer readable storage medium.

One or more of the embodiments described above may include one or more of the features described below.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a UE 50, generally, as opposed to discussion of particular instances of UEs 50a, 50b).

FIG. 1 is a schematic block diagram illustrating an example time-frequency grid of radio resources, according to one or more embodiments of the present disclosure.

FIG. 2 is a schematic block diagram illustrating an example SSB, according to one or more embodiments of the present disclosure.

FIG. 3A is a schematic block diagram illustrating an example SSB burst, according to one or more embodiments of the present disclosure.

FIG. 3B is a schematic block diagram illustrating an example SMTC cycle, according to one or more embodiments of the present disclosure.

FIG. 4 is a schematic block diagram illustrating an example wireless communication network, according to one or more embodiments of the present disclosure.

FIG. 5 is a schematic block diagram illustrating an example TCI configuration, according to one or more embodiments of the present disclosure.

FIGS. 6 and 7 are flow diagrams illustrating an example method implemented by a UE, according to one or more embodiments of the present disclosure.

FIGS. 8-10 are timeline diagrams illustrating examples of the timing of SCell activation, according to one or more corresponding embodiments of the present disclosure.

FIG. 11 is a flow diagram illustrating an example method of obtaining a Power Delay Profile (PDP) as implemented by a UE, according to one or more embodiments of the present disclosure.

FIG. 12 is a timeline diagram illustrating an example of PDP placement for an SCell to be activated, according to one or more embodiments of the present disclosure.

FIGS. 13 and 14 are timeline diagrams illustrating additional examples of the timing of SCell activation, according to one or more corresponding embodiments of the present disclosure.

FIG. 15 is a schematic block diagram illustrating an example of a UE, according to one or more embodiments of the present disclosure.

FIG. 16 is a schematic block diagram illustrating an example wireless network, according to one or more embodiments of the present disclosure.

FIG. 17 is a schematic block diagram illustrating an example UE, according to one or more embodiments of the present disclosure.

FIG. 18 is a schematic block diagram illustrating an example virtualization environment, according to one or more embodiments of the present disclosure.

FIG. 19 is a schematic block diagram illustrating an example telecommunication network connected via an intermediate network to a host computer, according to one or more embodiments of the present disclosure.

FIG. 20 is a schematic block diagram illustrating an example host computer communicating via a base station with a user equipment over a partially wireless connection, according to one or more embodiments of the present disclosure.

FIGS. 21-24 are flow diagrams illustrating example methods implemented in a communication system, according to one or more embodiments of the present disclosure.

### DETAILED DESCRIPTION

Although the following disclosure will discuss embodiments that may be particularly useful in NR networks for purposes of explanation and illustration, other embodiments may be applied to other networks using similar principles as may be appropriate. Thus, embodiments of the present disclosure are not limited for use in other wireless communication networks, and particularly in such networks as may be promulgated by the Third Generation Partnership Project (3GPP).

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a UE 50, generally, as opposed to discussion of particular instances of UEs 50a, 50b).

It should be noted that the phrase “multiple SCell activation” and variations thereof will be used throughout this disclosure. As used herein, this phrase and its variants refer to the activation of two or more SCells in response to the same signal, e.g., an RRC or MAC command.

In wireless communication networks, handover to a new PCell, configuration of a new SCell, and configuration and activation of a new Primary Secondary Cell (PSCell) is usually based on measurement reports from the UE, where the UE has been configured by the network node to send measurement reports periodically, at particular events, or a combination thereof. The measurement reports typically contain physical cell identity, Reference Signal Received Power (RSRP) and Reference Signal Received Quality (RSRQ) of the detected cells.

Cell detection often involves aiming at, detecting, and determining a cell identity and cell timing of a cell, such as a neighbor cell. Cell detection traditionally is facilitated by two signals that are transmitted in each Evolved Universal Mobile Telecommunications Service (UMTS) Terrestrial Radio Access Network (RAN) (EUTRAN) cell on a 5 ms basis: i.e., the primary and the secondary synchronization signal (PSS and SSS, respectively). Moreover, reference signals (RSs) are transmitted in each cell in order to facilitate cell measurements and channel estimation.

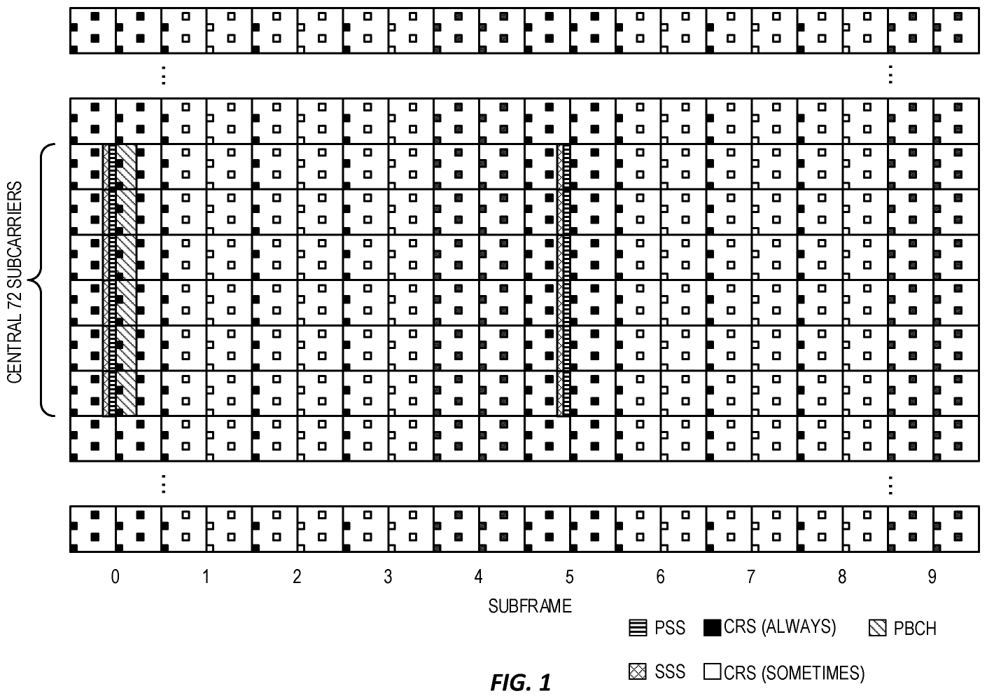

There are three common versions of the PSS. Each PSS version corresponds to a respective one of three cell-within-group identities. The PSS is based on Zadoff-Chu sequences that are mapped onto the central 62 subcarriers and bordered by 5 unused subcarriers on either side. There are in total 168 cell groups, and information on to which cell group a cell belongs is carried by the SSS, which is based on m-sequences. This signal also carries information on whether it is transmitted in subframe 0 or subframe 5, which is used for acquiring frame timing. For a particular cell, the SSS is further scrambled with the cells cell-within-group identity. Hence, in total, there are 2x504 versions, two for each of the 504 physical layer cell identities. Similar to PSS, SSS is mapped onto the central 62 subcarriers and bordered by 5 unused subcarriers on either side. Synchronization signals (SSs) as may be suitable for use in an Long Term Evolution (LTE) Frequency Division Duplex (FDD) radio frame are shown in the time-frequency grid depicted in FIG. 1.

As shown, the time-frequency grid of a legacy LTE FDD cell is wider than the smallest downlink system bandwidth of 1.4 MHz (72 subcarriers or 6 RBs). Subframes 1-3 and 6-8 may be used for Multimedia Broadcast Single Frequency Network (MBSFN) or may be signaled to do so for other purposes, by which a UE cannot expect reference signals in more than the first Orthogonal Frequency Division Multiplexing (OFDM) symbol. The Physical Broadcast Channel (PBCH) (which carries the Master Information Block (MIB)) and synchronization signals are transmitted at prior known OFDM symbol positions over the central 72 subcarriers.

Synchronization signaling may operate differently in NR than in LTE. The SSB may be the only signals that can be assumed to be present in the NR cell (unless it has been signaled that the SSB is not transmitted). The SSB may be used for cell detection and measurements such as SS-RSRP, SS-RSRQ, and SS-Signal-to-Interference-plus-Noise Ratio (SS-SINR). Depending on frequency range, the SSB may also be used for so called “beam management,” i.e., for allowing the UE to determine which subset out of a plurality of beams transmitted in the cell is most suitable to use in the communication between network node and UE.

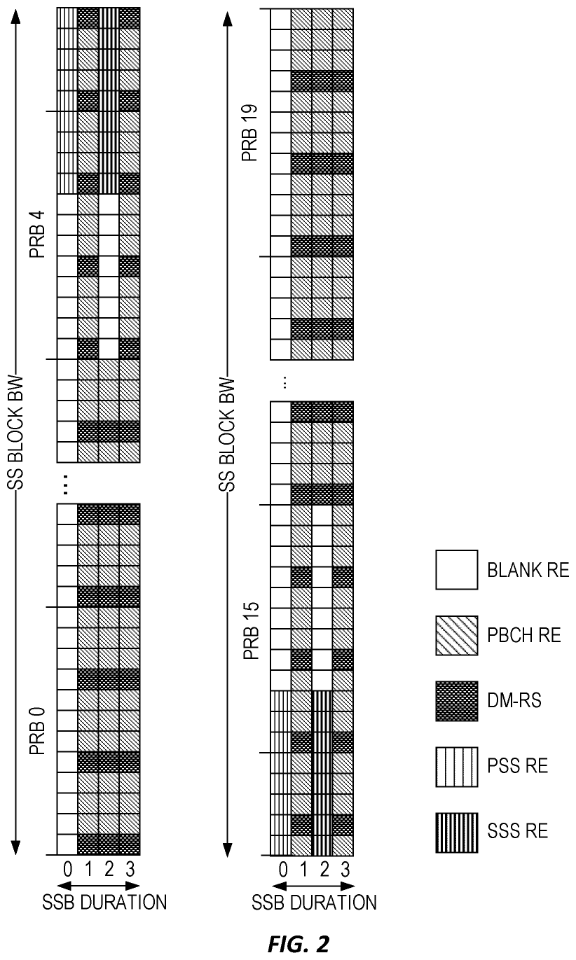

The SSB of certain embodiments comprises a PSS, SSS, PBCH and Demodulation Reference Symbols (DM-RS). The individual SSB spans four adjacent OFDM symbols, as illustrated in FIG. 2.

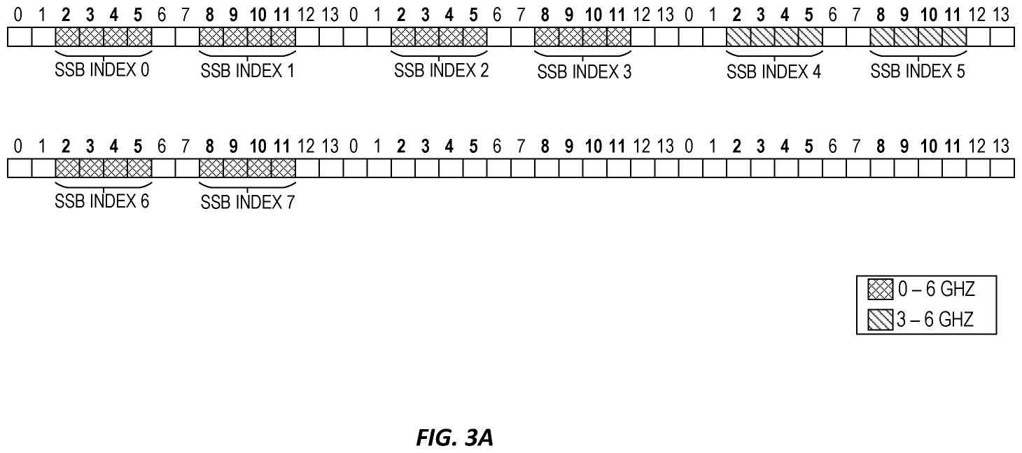

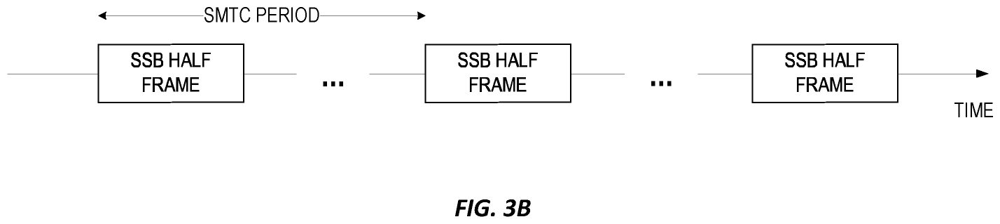

The SSB is transmitted within a half-frame (5 ms), commonly referred to as an SSB burst. In the half-frame, multiple SSBs for different cells or different beams may be transmitted, as shown in SSB half-frame with SSB burst in SCS 15 kHz numerology FIG. 3A. The number of SSB locations in a burst depends on the frequency range, as well as on the NR numerology (subcarrier spacing (SCS) and associated OFDM symbol length) in use. It should be noted that values of the symbol μ are commonly used to refer to numerology values. For example, p=0 is often used to refer to a numerology in which 15 kHz SCS is used, whereas μ=1 is often used to refer to a numerology in which 30 kHz SCS is used. Notwithstanding, embodiments of the present disclosure may be used with different numerologies, different SCS, and/or different numerology values.

In NR, the spectrum is divided into at least two frequency ranges, e.g., frequency range 1 (FR1) and frequency range 2 (FR2). FR1 is currently defined as being from 450 MHz to 7000 MHz. FR2 is currently defined as being from 24250 MHz to 52600 MHz. The FR2 range is also interchangeably called millimeter wave (mmwave) and corresponding bands in FR2 are called mmwave bands.

For 15 kHz (numerology μ=0) and 30 kHz (numerology μ=1) SSB SCS (such as that used in FR1) the number of SSB positions (also referred to as SSB indexes) is up to 4 for carrier frequency range 0-3 GHz, and up to 8 for carrier frequency range 3-6 GHz. Each index may represent a different transmission (Tx) beam or sector in a cell.

The SSB burst (and the individual SSBs within) are transmitted according to an SMTC cycle, which may have a periodicity of 5, 10, 20, 40, 80 or 160 ms, e.g., as shown in FIG. 3B. A typical network configuration for FR2 is that the SMTC period is 20 ms.

The UE is configured by the network node (e.g., eNB, gNB, or more generally “base station”) with an SMTC for each NR carrier it is to measure. The SMTC contains information, e.g., regarding the SMTC period and SMTC offset. The SMTC offset is expressed as a number of subframes, each of length 1 ms, within the range 0 to SMTC period-1, and is using the frame border of system frame number 0 of the serving cell as reference.

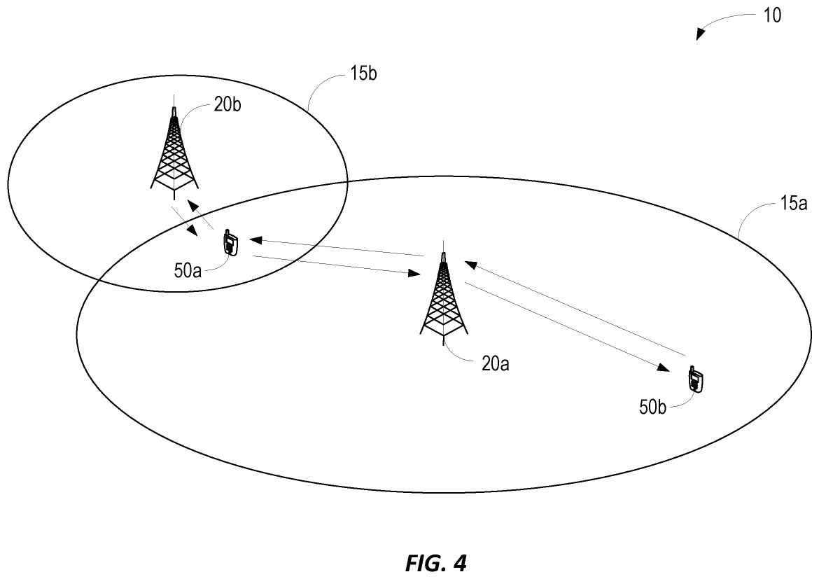

FIG. 4 illustrates a wireless communication network 10 consistent with the NR standard currently being developed by 3GPP. Wireless communication networks 10 consistent with embodiments of the present disclosure may, for example, comprise at least one network node 20 providing service to one or more UEs 50 in at least one cell 15 of the wireless communication network 10. The network node 20 may also be referred to as a base station, evolved NodeB (eNB) and/or gNodeB (gNB) in accordance with 3GPP standards.

According to the example illustrated in FIG. 4, network node 20a serves a PCell 15a to UEs 50a, 50b, whereas network node 20b serves an SCell 15b to UE 50a and does not serve UE 50b. In general, a network node 20 may add, release, and/or reconfigure an SCell for one or more UEs 50. When an SCell is initially configured by a network node 20, that SCell must typically be subsequently activated.

Although only two cells 15a, 15b served by respective network nodes 20a, 20b are shown in FIG. 4, other wireless communication networks 10 consistent with the present disclosure may comprise other network nodes 20 serving other cells 15 to other UEs 50, for example. Note that as used herein, the term “base station” and “network node” may be used interchangeably.

The UEs 50 may comprise any type of equipment capable of communicating with the network node 20 over a wireless communication channel. For example, the UEs 50 may comprise cellular telephones, smart phones, laptop computers, notebook computers, tablets, machine-to-machine (M2M) devices (also known as machine type communication (MTC) devices), embedded devices, wireless sensors, or other types of wireless end user devices capable of communicating over wireless communication networks 10.

In an IOT scenario, a UE 50 as described herein may be, or may be comprised in, a machine or device that performs monitoring or measurements, and transmits the results of such monitoring measurements to another device or a network. For example, a UE 50 as described herein may be comprised in a vehicle and may perform monitoring and/or reporting of the vehicle's operational status or other functions associated with the vehicle.

The network node 20 is configured to receive signals transmitted from the corresponding one or more UEs 50 on an uplink, and transmit signals to the one or more corresponding UEs 50 on a downlink. The UEs 50 are configured to receive signals transmitted from the network node 20 on the downlink, and transmit signals to the network node 20 on the uplink.

Upon the network node 20 configuring the UE 50 with an SCell, the SCell is typically in a deactivated state, i.e., a UE power saving state in which the UE 50, e.g., cannot be scheduled on that SCell. The network node can activate the SCell by sending an activation command, e.g., via MAC signaling. At SCell activation, depending on whether the cell is known or not, the UE may have to go through a few steps that (at least in the minimum configuration with respect to transmitted or broadcasted signals in a cell) are based on reception of an SSB. The steps include, for example, Automatic Gain Control (AGC), gain setting, detection of the SCell to be activated and/or optimum Tx beam (SSB index) to use, and/or measurement and reporting of Channel State Information (CSI). For UEs in FR2, the activation procedure may additionally include determining which UE Receive (Rx) beam to use (by so called Rx beam sweeping). This means that the activation time gets dependent on the SMTC period in use, as well as on the number of spatial directions (UE Rx beams) that the UE searches over in the beam sweeping. The assumption used in the standard is that a UE may have to search up to 8 spatial directions.

The SCell activation time requirements in NR so far only comprises requirements on activation of a single SCell at a time. Thus, activation of multiple SCells according to current NR standards requires sending multiple activation commands, i.e., one for each of the SCells to be activated. The SCell activation time differs depending on which frequency range (FR) the SCell belongs to, on whether the SCell is known or unknown, and whether there already is at least one active serving cells in the frequency band where a SCell in FR2 is to be activated.

The activation time may be represented by a generic expression stating that for reception of activation command in slot n, the UE shall have completed the activation of the SCell no later than by slot n+T_{HARQ}+T_{activation_time}+T_{CSI_Reporting}, where T_{HARQ} is the time between DL data transmission and acknowledgement as specified in 3GPP TS 38.321, and T_{CSI_Reporting} is the time required for acquiring the first available CSI-RS and the first available uplink resources for CSI reporting.

For a known SCell in FR2 that is the first serving cell to be activated in the FR2 band and in which Transmission Configuration Indication (TCI) state activation is received in the same command, the activation time is T_{activation_time}=T_{MAC-CE,SCell}+T_{FineTiming}+2 ms, where T_{MAC-CE,SCell} is likely to be approximate 2-3 ms, and T_{FineTiming} represents the time to acquire the first SSB after having decoded the MAC-CE carrying the activation command. It has the same role as T_{SMTCS_CELL} for SCell activation in FR1.

For a known SCell in FR2 that is the first serving cell to be activated in the FR2 band and in which TCI state activation is received at a later point in time than the SCell activation command, the activation time is T_{activation_time}=max{T_{MAC-CE,SCell}, T_{uncertainty}} T_{MAC-CE_TCI}+T_{FineTiming}+2 ms, where T_{uncertainty} is the time period between reception of SCell activation MAC-CE and TCI activation MAC-CE for known case, and T_{MAC-CE_TCI} is to be decided but should be in the order of 2-3 ms.

For known or unknown SCell in FR2, and there already is an activated serving cell in the concerned FR2 band, the activation time is T_{activation_time}=T_{SMTC_SCell}+5 ms. Here, similar to the case for FR1, T_{SMTC_SCell} represents the time to acquire one SSB for updating control loops (Automatic Timing Control (ATC)/Automatic Gain Control (AGC)/Automatic Frequency Control (AFC)) before carrying out CSI measurements.

For unknown SCell in FR2, and first serving cell to be activated in the FR2 band, the activation time is T_{activation_time}=T_{MAC-CE,SCell}+24×T_{SMTC_SCell}+T_{L1-RSRP,measure}+T_{L1-RSRP,report}+T_{uncertainty}+T_{MAC-CE,TCI}+T_{FineTiming}+2 ms, where 24×T_{SMTC_SCell} represents the time for acquiring 24 SSBs for conducting cell detection under beam sweeping, T_{L1-RSRP,measure} represents time for conducting L1-RSRP measurements on SSBs, T_{L1-RSRP,report} represents time for acquiring the first UL resources for L1-RSRP reporting after the L1-RSRP measurement has been conducted, and T_{CSI-RS_resource_configuration} is the time for CSI-RS resource configuration for Channel Quality Indicator (CQI) reporting. The meaning of T_{uncertainty} in this scenario is different from above, here describing the time between the first (valid) L1-RSRP report by the UE and until the UE receives a MAC-CE with TCI state activation.

As used herein, an SCell in a FR2 band within which there is no serving cell is considered to be known if, for some defined interval of time before the UE receives the last activation command for the Physical Downlink Control Channel (PDCCH) TCI, Physical Downlink Shared Channel (PDSCH) TCI (when applicable) and semi-persistent CSI-RS for CQI reporting (when applicable), the UE has sent a valid L3-RSRP measurement report with SSB index and the SCell activation command is received after L3-RSRP reporting and no later than the time when UE receives MAC-CE command for TCI activation. It is also required that during the period from L3-RSRP reporting to the valid CQI reporting, the reported SSBs with indexes remain detectable according to the cell identification conditions specified in clauses 9.2 and 9.3 of 3GPP TS 38.133, and the TCI state is selected based on one of the latest reported SSB indexes in order for the UE to be considered “known.” For UEs supporting power class 1, the defined interval of time is equal to 4 s. For UEs supporting power class 2, 3, and/or 4, the defined interval of time is equal to 3 s.

In order to perform SCell activation in FR2, there are certain requirements which have been established. For example, with respect to intra-band carrier aggregation in FR2, in order to be in the RRC connected state, the UE assumes that the transmitted signals from serving cells have the same downlink spatial domain transmission filter on one OFDM symbol in the same band in FR2. Otherwise, the UE is not supposed to satisfy any requirements for SCell.

The Maximum Receive Time Difference (MRTD) for intra-band non-contiguous carrier aggregation in FR2 is specified as 0.26 μs, whereas for FR1-FR2 inter-band carrier aggregation, the MRTD is 25 μs.

A UE in FR2 is configured by the network node with one active TCI (transmission configuration indication) state for PDCCH (physical downlink control channel) and PDSCH (physical downlink shared channel), respectively. The active TCI indicates, for each of the channels, which timing reference the UE shall assume for the downlink reception. The timing reference may be with respect to an SSB index associated with a particular Tx beam, or with respect to a particular DL-RS (downlink reference signals, e.g. channel state information reference signals— CSI-RS) resource configured by the network node and provided (i.e. transmitted) to the UE.

Implicitly, the active TCI state additionally indicates to the UE which UE Rx beam to use when receiving PDCCH and/or PDSCH, since it shall use the Rx beam that allows best conditions for receiving the SSB index or DL-RS resource associated with the TCI state. Note that the best UE RX beam for a given TCI state may change over time e.g. if the UE orientation changes, but also has to be relatively static at least over short time intervals.

Up to 8 TCI states can be configured for PDSCH via higher layer signaling (e.g., RRC signaling), but only one TCI state can be active at any time. In case several TCI states are configured by the network node, the network node indicates to the UE via Downlink Control Information (DCI) signaling over PDCCH which one of the pre-configured TCI states to activate for upcoming PDSCH reception(s).

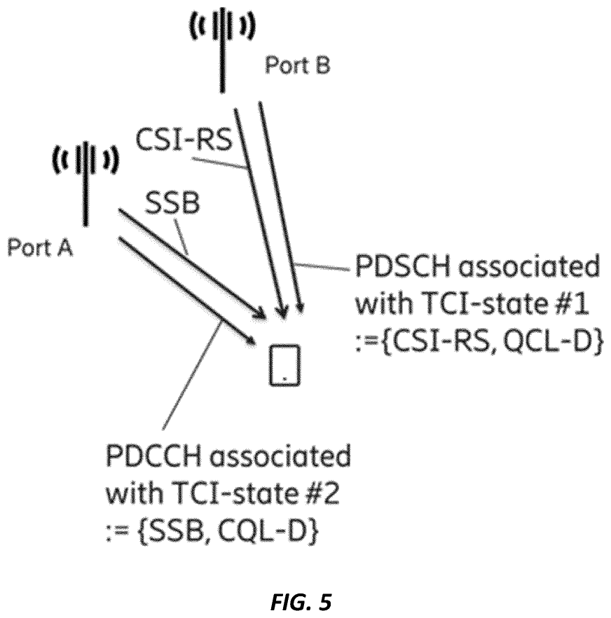

FIG. 5 illustrates an example of TCI configuration. In this example, the network configures 2 TCI states; TCI state #2 corresponds to the SSB beam from antenna port A and TCI state #1 corresponds to the CSI-RS beam from antenna port B. In this example, PDSCH is associated with TCI state #1 and PDCCH is associated with TCI state #2. This means UE assumes PDSCH is transmitted on the same Tx beam that CSI-RS is transmitted, and PDCCH is transmitted on the same Tx beam that SSB is transmitted.

The SCell activation delay for activation of multiple SCells has yet to be specified for NR (e.g., in 3GPP Rel-16). It is commonly believed that sequential activation of SCells (aspects of which have been touched upon above) may be required, e.g., out of concern that alternatives might increase the required complexity of the UE 50. Notwithstanding, embodiments of the present disclosure enable parallel activation of SCells, e.g., without substantially increasing UE 50 complexity by adding dedicated hardware and/or without significantly increasing computational burden, if at all. As used herein, “parallel activation” of a plurality of cells means that the activation time of each of the cells in the plurality of cells at least partly overlaps with each of the other cells in the plurality of cells.

Sequential activation would likely mean that it takes longer for the system to configure and start using the total aggregated bandwidth of the UE 50, thereby potentially jeopardizing end-user experience. Moreover, a slower adaptation to the required bandwidth would likely pose one or more problems for the network node 20, such as slower load balancing and/or increased risk of downlink buffer overrun. One way to mitigate such problems may be to generally keep more SCells active, which may serve as a buffer for varying bandwidth demand from the UE 50. However, this approach may negatively impact UE power consumption.

Particular embodiments of the present disclosure avoid one or more of these drawbacks, and/or allow for speedy activation of multiple SCells relative to known alternatives. Moreover, particular embodiments may provide one or more such advantages without introducing increased UE hardware complexity and/or computational complexity.

Particular embodiments of the present disclosure exploit the fact that carrier aggregation in FR2 is under both spatial and temporal constraints with regard to which cells can be aggregated. With respect to the spatial constraints, aggregated cells in an FR2 band are to be received by the UE using the same set of Rx beams (e.g., the cells may be treated as being co-located). With respect to the temporal constraints, cells in FR2 intra-band non-contiguous carrier aggregation are to be received within a MRTD of 0.26 μs. This means, for example, that if two SCells are to be activated simultaneously as the first cells in a FR2 band, and one of the SCells is known (as defined above, i.e., SSB index for which PDCCH TCI is configured is known, frame timing is known, and the set of UE Rx beams to use is known) but the other SCell is not known, the latter SCell can inherit the information from the first SCell. As a result, the two cells can be activated in parallel within the same delay as if a single SCell been activated.

Similar constraints can be exploited when the two SCells to be activated are unknown, to optimize the multiple SCell activation. Namely, cell detection and L1-RSRP measurements only have to be carried out for one of the SCells and then applied to both SCells. In the preferred embodiment, both SCells can be activated in parallel within the same delay as had a single SCell been activated.

Accordingly, particular embodiments of the present disclosure allow for parallel activation of SCells without significant impact on UE hardware complexity (e.g., no new cell detection/SSB index detection hardware capacity needed) and/or computational complexity (e.g., activation of the SCells can be performed within the budget for digital signal processing capacity and data memory for the purpose of channel estimation and channel reception). Parallel activation may allow for the desired end-user bandwidth to be achieved sooner, with benefits both for the end-user experience and for the system performance. Such system performance gains may include faster adaptation for load balancing and/or reduced risk for downlink buffer overrun.

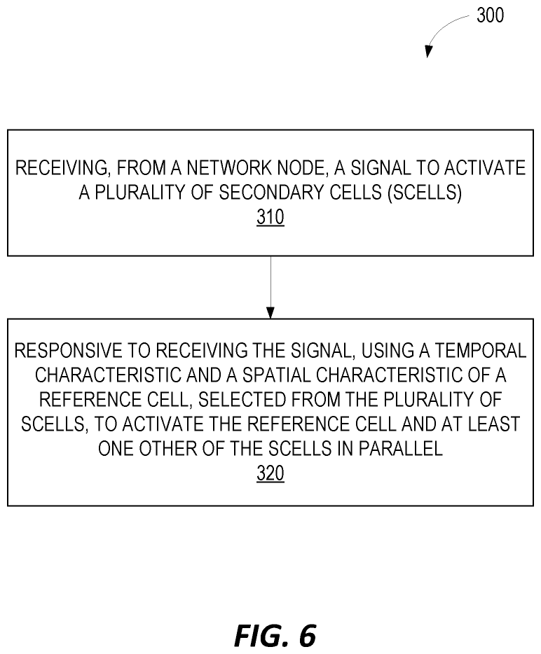

One or more embodiments of the present disclosure include a method 300 of parallel secondary cell (SCell) activation, implemented by a UE 50 (e.g., as shown in FIG. 6). The method 300 comprises receiving, from a network node 20, a signal to activate a plurality of secondary cells (SCells) (block 310), and in response, using a temporal characteristic and a spatial characteristic of a reference cell, selected from the plurality of SCells, to activate the reference cell and at least one other of the SCells in parallel (block 320).

In some embodiments, using the spatial characteristic of the reference cell comprises using a receiving beam steered in a same direction suitable for receiving the reference cell to monitor for a synchronization signal of the other one of the SCells being activated in parallel. In some embodiments using the temporal characteristic of the reference cell comprises, for the other SCell being activated in parallel, locating a frame timing of the SCell based on a threshold uncertainty interval relative to a timing of the reference cell.

For example, in some embodiments, the UE 50 determines for the set of FR2 SCells to be added, which spatial and temporal constraints are set by active serving cells or by known SCells to be activated. The UE 50 may then group the SCells into a first activation group and a second activation group of SCells for activation. The SCells in the second activation group depend on one or more spatial and/or temporal constraints set by the SCells in the first activation group or by an active serving cell. The UE starts with activation of SCells in the first group (if any) and then activates the SCells in the second group, exploiting the spatial and temporal constraints set by the first activation group or an active serving cell.

In some embodiments, the UE 50 may additionally check L1-RSRP prior to activating the SCells in the second group, e.g., as a verification step.

Turning now to more detailed examples, according to one or more embodiments, the UE 50 may receive an SCell activation command for two or more FR2 SCells. In response, the UE 50 may check whether there is an active serving cell in the FR2 band, and whether any of the SCells to be activated in the FR2 band are known (as defined above). If there is an active serving cell in the FR2 band and/or one or more of the SCells to be activated in the FR2 band are known, then activation of each of the SCells may be performed using characteristics of the active serving cell and/or known SCells. These characteristics include a set of UE receiving (Rx) beams to use, the SSB index to receive in each cell, and/or the time interval over which the SSB index can be received in each SCell to be activated. Further, all of the SCells to be activated may be sorted into the second activation group (thereby leaving the first activation group empty).

If there is not an active serving cell in the FR2 band and none of the SCells to be activated in the FR2 band are known, then embodiments include sorting at least one of the SCells into each of the first and second activation groups.

SCell(s) in the first activation group are activated without prior knowledge on which set of UE Rx beams to use, and may additionally be activated without first having been configured with active TCI states, by which the UE may have to carry out L1-RSRP measurement and report to the network node before TCI state activation. The uncertainty on frame timing is up to ±25 μs relative to a serving cell in FR1 (MRTD for FR1-FR2 inter-frequency carrier aggregation ±25 μs).

SCell(s) in the second activation group are activated with prior knowledge from a reference cell (e.g., a known SCell to be activated or constraints from active serving cell(s)) on which set of UE Rx beams to use, and which SSB index to receive. The uncertainty on frame timing is up to ±0.26 μs relative to a serving cell in the same FR2 band, potentially a little more in case the timing is derived from a known SCell to-be-activated (in accordance with the MRTD FR2 intra-frequency non-contiguous carrier aggregation). Optionally, the UE may perform a verification phase, prior to completing activation of the SCells in the second group. A characteristic of the verification phase is that it should be significantly faster than the activation procedure used for SCells in the first group.

Non limiting examples of procedures to verify that an SCell in the second group has, or will be, successfully received include verifying that the secondary synchronization signal received in an SS-block matches the expected physical cell ID of the SCell. Additionally or alternatively, such verification may include measuring SS-RSRP of the SCell, e.g., in a single shot measurement or measurement with a short measurement period and checking that it is above a fixed, or signaled threshold. Additionally or alternatively, such verification may include measuring L1-RSRP on either SSB or CSI-RS for the SCell and verifying that it is above a threshold. In some such embodiments, the may be derived from the corresponding measurement of the SCell in the first group.

If it was determined by the UE that there are no constraints imposed by active serving cell(s) and none of the SCells to be activated are known, then the UE may select at least one SCell to be activated as the reference cell. For example, the UE may select at least one SCell to be included in the first activation group, which will serve as a basis for activating the SCells in the second activation group.

The UE may for instance select the at least one SCell for the first activation group (e.g., to be used as a reference cell) based on the SCell being configured with L1-RSRP reporting, when active TCI state is not provided at the time of receiving the SCell activation command. Additionally or alternatively, the UE may select the at least one SCell for the first activation group based on the SCell having the shortest SMTC period. Additionally or alternatively, the UE may select the at least one SCell for the first activation group based on the SCell having a particular index (e.g., lowest) or position (e.g., first) in a list of SCells to be activated in the MAC-CE activation command. Additionally or alternatively, the UE may select the at least one SCell for the first activation group based on which of the SCells to be activated has the shortest measurement cycle (measCycleSCell) or a smallest function thereof. Additionally or alternatively, the UE may select the at least one SCell for the first activation group based on which of the SCells to be activated has the shortest applicable DRX cycle or smallest function thereof. Additionally or alternatively, the UE may select the at least one SCell for the first activation group based on which SCell to be activated has a smallest Carrier Specific Scaling Factor (CSSF) (e.g., as defined in TS 38.133) or smallest function thereof. Additionally or alternatively, the UE may select the at least one SCell for the first activation group based on which of the SCells to be activated has the smallest function max(measCycleSCell, DRX cycle)*CSSF with the parameters relevant for the SCell. Additionally or alternatively, the UE may select the at least one SCell for the first activation group based on which of the SCells to be activated has the shortest measurement time (e.g., for L1-RSRP) and/or shortest cell detection. In some embodiments, the selection of an SCell for the first activation group may be left to UE implementation.

In case signalling is added (in RRC or MAC), the UE may instead select a SCell to-be-activated for the first activation group based on an indication from the network node.

Remaining SCells to-be-added are selected for the second activation group. The UE carries out activation first of SCells in the first activation group, and then of SCells in the second activation group. There are several embodiments by which the activation of these groups may be carried out, as described below.

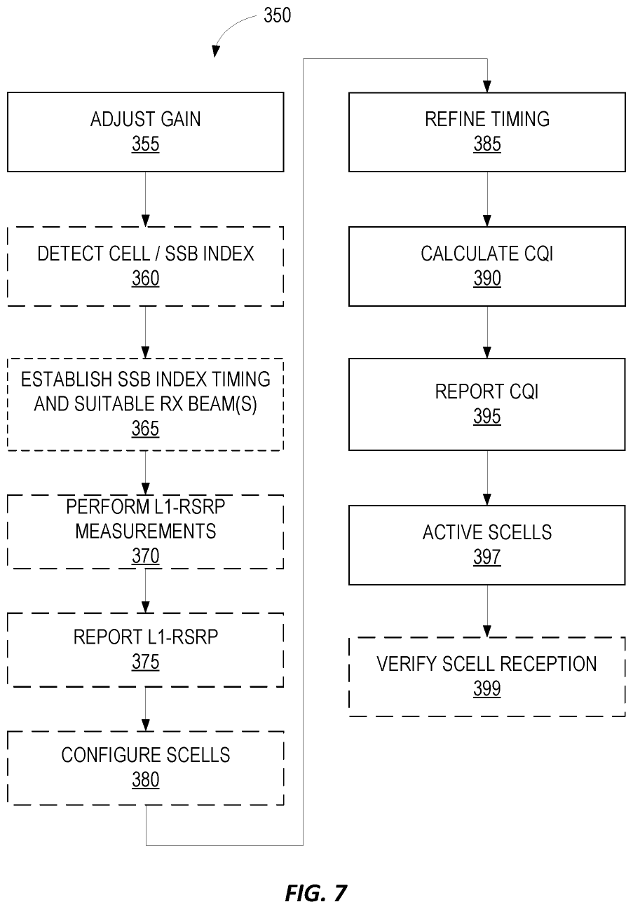

In some embodiments, there are one or more cells in the first activation group and the the activation of the groups is in accordance with the method 350, implemented by the UE 50, and as illustrated in FIG. 7, for example. The method 350 comprises adjusting gain over the one or more carriers in the FR2 band that will be active once the SCells are activated (block 355). In some embodiments, adjusting gain may comprises directly setting the gain. In other embodiments, adjusting the gain may comprise performing automatic gain control (AGC)

The method 350 further comprises performing cell detection and/or SSB index detection on a first SCell to be activated (hereinafter referred to as SCell A) (block 360). In some embodiments, this detection is performed using cell search hardware of the UE (a constrained resource) and with UE Rx beam sweeping. Having detected one or more relevant SSB indexes, the UE establishes each of the relevant SSB index's timing and the suitable set of UE Rx beams to receive it with (block 365).

The method 350 further comprises performing L1-RSRP measurements on an SCell in the first activation group (e.g., SCell A, SCell B), depending on CSI configuration from the network (block 370). The measurements may, for example, be carried out based on the information received in the cell detection (e.g., detected SSB indexes, sets of UE Rx beams, timing information), and with information provided in the network configuration e.g. on which SSB indexes and/or other reference signals (e.g. CSI-RS) to consider in the L1-RSRP measurement.

The method 350 further comprises reporting the L1-RSRP measurement to the network node (block 375). In response, the UE configures the SCells of the first activation group to be activated with active TCI states and CSI-RS for CQI measurements and/or activates the configurations (block 380).

Once TCI has been configured and activated, the UE refines a timing of each SCell to be activated, including those SCells that have not been explicitly detected or measured in previous steps (block 385). The detection and timing refinement may for instance be carried out using a Power Delay Profile, as will be discussed in greater detail below.

After the timing refinement, the UE calculates CQI based on CSI-RS provided by the network (block 390), and provides a valid (non-zero) CQI report to the network node for each of the network nodes (block 395). After this step, the SCells are activated (block 397). Note that in some embodiments, the successful reception of the remaining SCells may be verified, e.g., as discussed above (block 399).

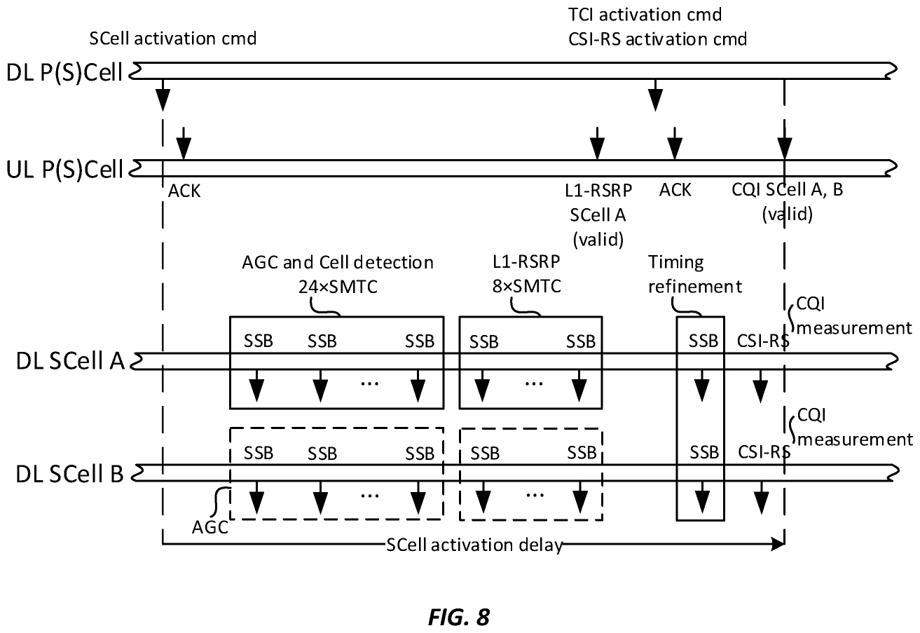

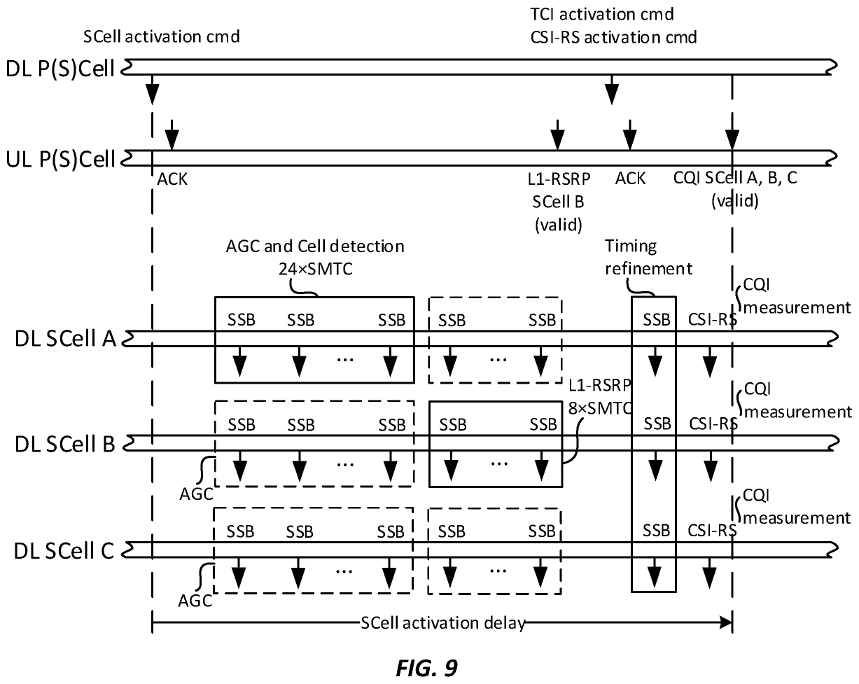

Embodiments consistent with the method 350 described above are illustrated in the examples shown in FIGS. 8 and 9, each of which shows parallel activation of FR2 cells in the same band, and in which the cells are unknown. Each of FIGS. 8 and 9 further shows activation of semi-persistent CSI-RS, otherwise additional RRC delay for periodic CSI-RS may be needed.

For simplicity of illustration, in the examples of FIGS. 8 and 9, it has been assumed that SMTC (SSB periodicity) is the same in all cells, and further, that CSI-RS are provided at the same time in all cells. This may not be the case according to other embodiments, but does not limit the applicability of aspects described herein (e.g., as shown in FIG. 7). In FIG. 8, a scenario where only SCell A is in first activation group is illustrated, whereas in FIG. 9, a scenario where both SCell A and SCell B are in first activation group is illustrated.

Other embodiments may involve fewer than all of the steps illustrated in FIG. 7. For example, when there are no cells in the first activation group, the method 350 may comprise determining and applying a gain setting for the SCell(s) to be activated (block 355) based on the known SCell to be activated or based on the active serving cell in the band. The method 350 further comprises carrying out timing refinement (block 385) for all SCells to-be-activated, where SSB index, timing and set of UE Rx beam is given by the configuration applicable for reception of the known SCell to-be-activated or the active serving cell in the band. For SCells to-be-activated that are unknown at the time of activation, the timing refinement may additionally comprises detection. The detection and timing refinement may for instance be carried out using a PDP-based approach, as will be described further below. After the timing refinement, the UE calculates CQI (block 390) based on CSI-RS provided by the network, and provides a valid (non-zero) CQI report to the network node for each of the network nodes (block 395). After this step, the SCells are activated (block 397).

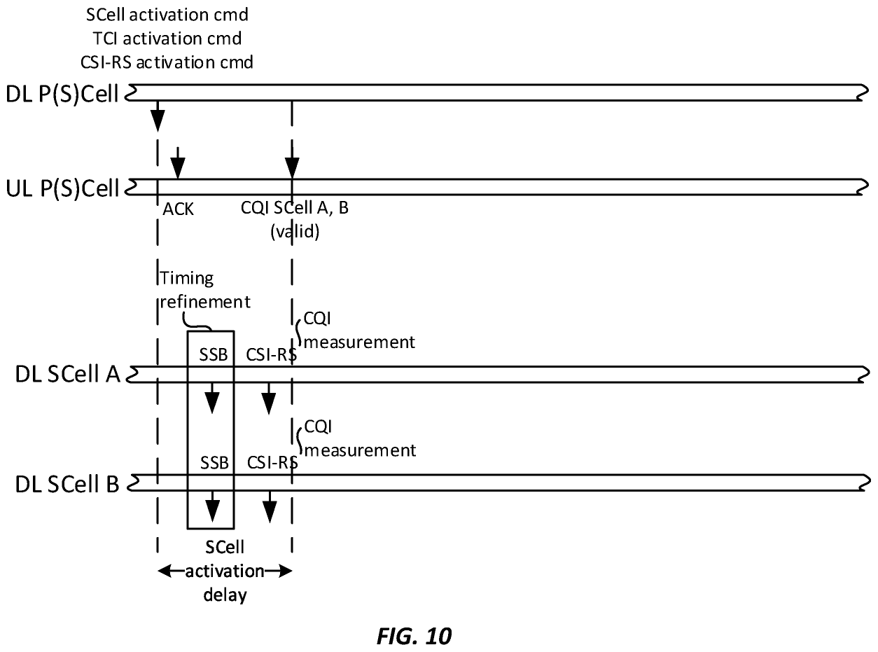

An example flow of one or more embodiments consistent with the above is illustrated in FIG. 10. In the example of FIG. 10, parallel SCell activation is performed in the same FR2 band, and at least one of cell A and cell B is known. The timing and/or gain from the known cell(s) may be used to activate an unknown cell. In some embodiments, the gain setting from a known cell is extrapolated for use in an unknown cell. As in earlier timing diagrams, for simplicity it has been assumed that SMTC (SSB periodicity) is the same in all cells, and further, that CSI-RS are provided at the same time in all cells. This may not be the case according to other embodiments, but such does not limit the applicability of the features disclosed herein, e.g., as discussed above with respect to FIG. 7.

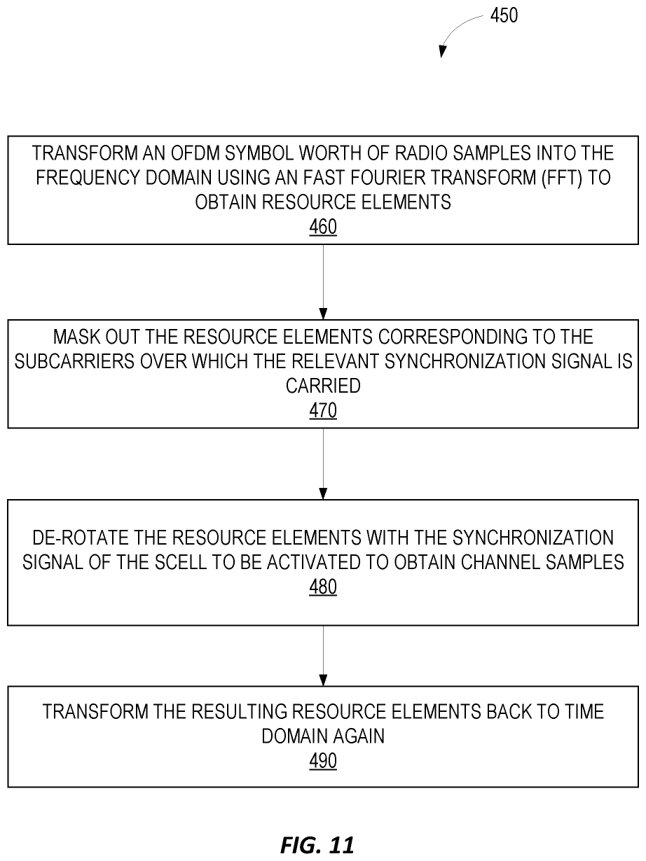

One or more embodiments discussed herein may further be based on usage of one or more PDPs, e.g., to cover the applicable time interval for each SCell to be detected in the second activation group. A PDP may be obtained by a UE 50, e.g., in accordance with the example method 450 illustrated in FIG. 11. As shown in FIG. 11, the UE 50 may transform an OFDM symbol worth of radio samples into the frequency domain using an Fast Fourier Transform (FFT) to obtain resource elements (block 460), mask out the resource elements corresponding to the subcarriers over which the relevant synchronization signal (e.g., SSS or other reference signal used for activation) is carried (block 470), de-rotate the resource elements with the synchronization signal of the SCell to be activated to obtain channel samples (block 480), and then transform the resulting resource elements back to time domain again (block 490).

A peak value indicates the strength of the detection, and a peak position indicates the time shift (within ±½ OFDM symbol) of the detected signal, if any, relative to the time interval over which the PDP was taken. A single PDP is adequate for most embodiments discussed herein since the timing uncertainty of such embodiments is expected to be less than ±½ OFDM symbol (one OFDM symbol is about 8 μs in SCS 120 kHz and 4 μs in SCS 240 kHz).

Notwithstanding, consecutive PDPs may be used in some embodiments, e.g., to cover uncertainties that are larger than ±½ OFDM symbol, and the results can be combined in various manners for improving the detection and removing ambiguities on where in time the detected signal is located. The computational complexity for deriving a PDP is less than the complexity needed e.g. for channel estimation, and as the UE yet not is in a state where it can receive PDCCH or PDSCH in the SCell to be activated, the PDPs can be calculated using resources that otherwise are budgeted for channel estimation and channel reception.

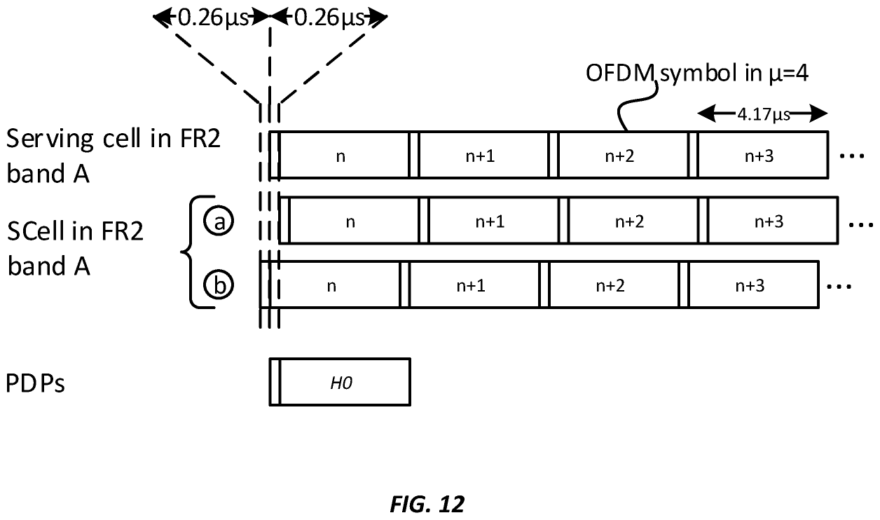

An example of placement of PDP for an SCell to be activated in FR2 when timing is provided by an intra-band cell or when the SCell to be activated is known is shown in FIG. 12. In the example of FIG. 12, example SCells (a) and (b) indicate the maximum lag and maximum lead, respectively, of the SCell to be activated relative to the timing of the reference cell.

Other particular embodiments may vary in certain details, yet nonetheless take advantage of one or more of the features discussed above. For example, according to particular embodiments in which there is exactly one SCell in the first activation group, the UE may refrain from activating SCells in the second activation group until a valid CQI for the SCell in the first group has been transmitted by the UE. In other words, the SCell activation procedure for the SCell in the first activation group may be completed (e.g., from the physical layer perspective) before the UE starts with activation of the SCells in the second activation group. Despite this variation in activation timing between the activation groups relative to some of the embodiments described above, the SCells within the second activation group itself are nonetheless still activated in parallel manner.

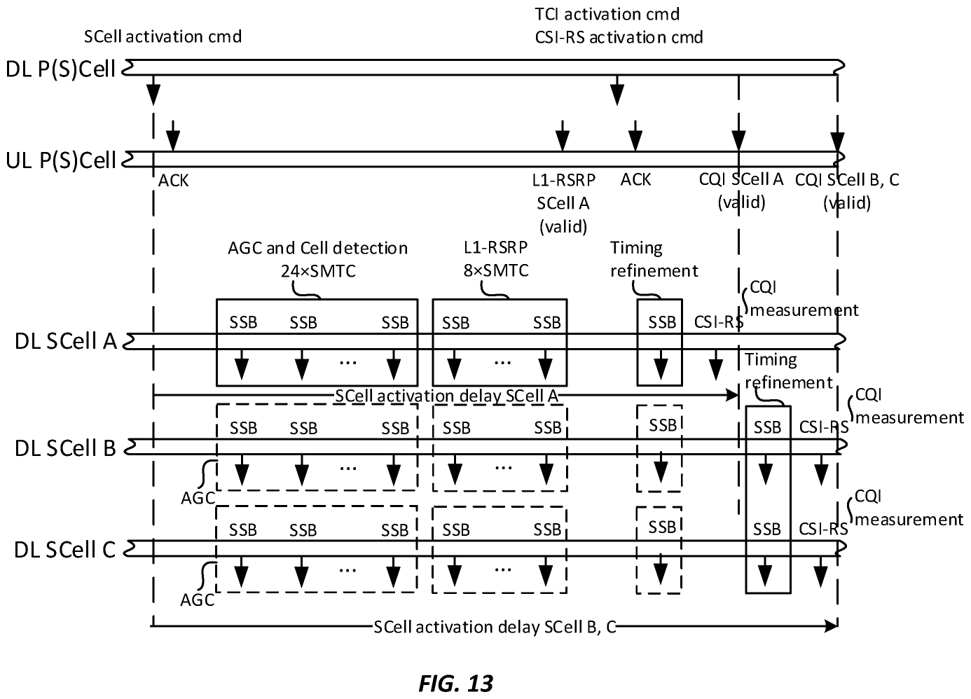

In this embodiment, an additional delay in activating remaining SCells comprises the time between activation of TCI state and until CQI has been reported for the SCell in first activation group. This difference can be seen when comparing the activation timeline for SCell B in FIG. 13 (consistent with this embodiment) to that of SCell B in FIG. 8 with respect to previously discussed embodiments. FIG. 13 illustrates parallel activation of FR2 cells in same band when the cells are unknown, and shows activation of semi-persistent CSI-RS (otherwise additional RRC delay for periodic CSI-RS may be needed). A noteworthy difference between the example of FIG. 13 as compared to that in FIG. 8, for example, is that timing refinement of SCells B and C cannot start until after a valid CQI has been reported for SCell A. Accordingly, activation of SCells in second activation group (SCells B and C) is started after the valid CQI is reported for SCell A.

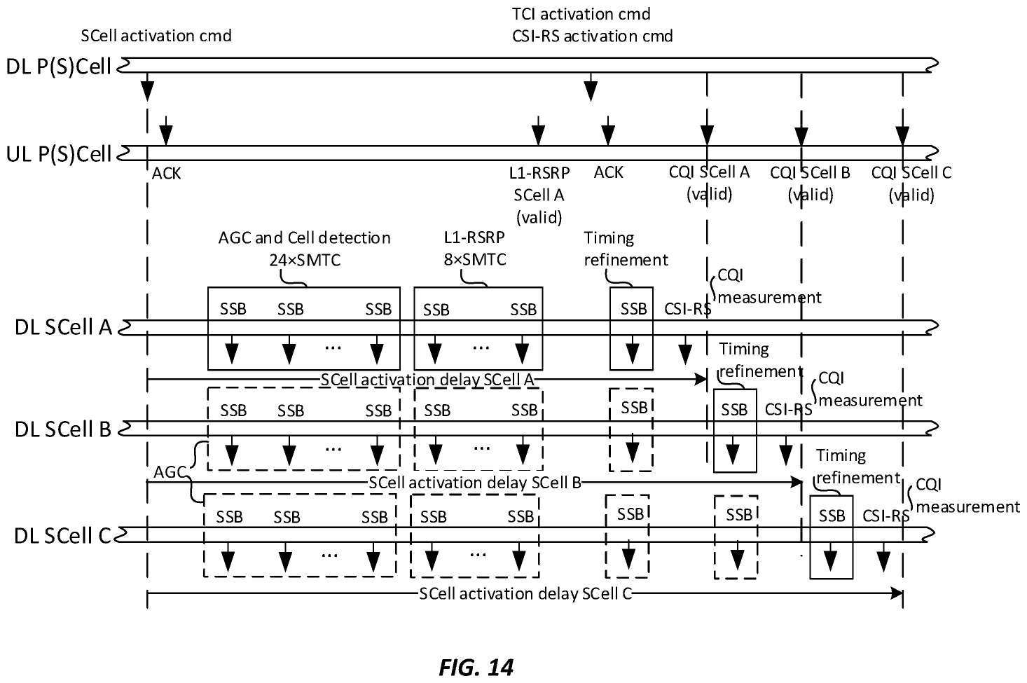

Yet other embodiments may comprise a strictly sequential activation of SCells. According to such embodiments, the first activation group only contains one SCell (if any), and second activation group contains the remaining SCells. The SCells in the second activation group are activated sequentially, as shown in FIG. 14. FIG. 14 illustrates activation of FR2 cells in same band, and in which the cells to be activated are unknown. According to this example, activation is carried out in sequential manner. In this example, the first activation group comprises SCell A, and the second activation group comprises SCells B and C.

According to such sequential embodiments, the SCells in the second activation group may be activated in their order in the activation command, e.g., based on the SCellindex. Alternatively, the order may be based on similar ordering principles as described for SCell selection for activation of the first activation group as described above.

It should be further noted that one or more SCells may be activated in other frequency ranges. In some embodiments, the frequency ranges in which SCells are activated may be disjoint. For example, some SCells may be activated in FR1 whereas others are activated in FR2.

To activate at least two additional SCells in a first frequency range (e.g., FR1), the UE may locate respective synchronization signals for the at least two additional SCells based on respective SSBs received from the network node in a same SSB burst. The UE may then activate the at least two additional SCells in parallel within the different frequency range using the synchronization signals located based on the respective SSBs. In such embodiments, using the temporal characteristic and the spatial characteristic of the reference cell to activate the at least two SCells in parallel (e.g., as described above and illustrated in the example of FIG. 6) may comprise activating the at least two SCells in parallel within a second frequency range (e.g., FR2), which is disjoint from the first frequency range.

Further, according to embodiments in which at least one SCell to be activated is in a different frequency range than another SCell to be activated in a set of SCells to be activated, the UE may receive a request to activate a set of SCells in at least one of an FR1 and an FR2, and activate a maximum number of SCells in the set the UE is capable of activating in parallel. The UE may then activate a set of remainder SCells from the set of SCells after activating the maximum number of SCells in the set.

Additional detail regarding the activation of SCells in other frequency ranges, and the order in which SCells are activated (e.g., in different frequency ranges, such as when the UE is configured for multicarrier operation) may be found in the Appendix hereto. Among other things, particular embodiments include the UE being configured for multicarrier operation (e.g. carrier aggregation and/or dual connectivity) involving at least two bands where one band belongs to FR1 and another band belongs to FR2. The UE is further configured to activate at least two SCells where at least one SCell, a first SCell (SCell1) to be activated belongs to the FR1 band and at least one SCell, a second SCell (SCell2) to be activated belongs to the FR2 band.

In one such example, the UE is capable of activating K number of SCells with at least 2 SCells belonging to different FRs, in parallel i.e. over at least partially overlapping time. If the UE with this capability is configured to activate up to K SCells with at least 2 SCells of different FRs then the UE activates the K SCells in parallel over an overlapping time. But if the UE with this capability is configured to activate L SCells with at least 2 SCells of different FRs then the UE activates the K SCells in parallel over an overlapping time, and starts the activation of the remaining (L-K) SCells after at least one of K SCells have been activated. For example if K=2 then the UE can activate SCell1 and SCell2 in parallel. But if the UE is configured to activate 3 SCells e.g. SCell1, SCell2 and SCell3 which belongs to FR1 then the UE can activate only SCell1 and SCell2 in parallel and SCell3 after at least one of the SCell1 and SCell2 is activated.

In another such example, the UE may not have the capability of activating multiple SCells belonging to different FRs in parallel i.e. K=1. If the UE with this capability is configured to activate two or more SCells with at least 2 SCells belonging to different FRs then the UE first determines an order in which the UE selects the frequency range FR whose one or more SCells are to be activated first. The selection is based on a rule, which is pre-defined or configured by the network or based on the UE implementation.

The rule, if pre-defined, may be realized by a pre-defined requirement (e.g., time to activate the SCell). In some embodiments, the rule is that the UE first activates SCell(s) which belong to a particular FR. The particular FR can be pre-defined or configured by the network node. As an example the UE first activate the SCells of FR1.

In other embodiments, the UE first activates SCell(s) whose activation delay (i.e. time to activate that SCell). The activation delay may depend on the radio conditions, density of reference signal, periodicity of reference signals (e.g. SMTC period etc). For example, the UE first activate SCell2 if the SMTC for carrier of the SCell2 on the FR2 band is shorter than the SMTC for carrier of the SCell1 on the FR1 band.

In other embodiments, the UE first activates SCell(s) which are known to the UE (e.g., the UE has measured the SCell or it has acquired the SSB index in the last X seconds).

In other embodiments, the UE first activates SCell(s) of an FR based on a number of SCells to be activated in an FR. In one such example, the UE first activate SCell(s) of an FR that contains smallest number of SCells.

In other embodiments, the UE activates one SCell of each FR in an alternative manner to enable statistically similar activation times for SCells of different FRs. The order in which the UE starts the activation wrt FR can be based on any of the rules or configuration message from the network node.

In other embodiments, the UE is explicitly configured with an FR whose SCells are to be activated first.

To effectuate incorporation of one or more of the embodiments discussed herein, the following rules may, for example, be introduced into 3GPP TS 38.133 for activation of multiple SCells in FR2, when not interrupted by radio reconfigurations for other purposes. In particular, an SCell in FR2 under activation fulfills the known cell condition if any other SCell under activation in the same band fulfills the known SCell condition, and the SSB index associated with the corresponding TCI state fulfills the cell identification side conditions in clauses 9.2 and 9.3 in 3GPP TS 38.133. When multiple SCells in FR2 are activated by the same MAC-CE command, each SCell shall fulfill the SCell activation delay requirement in 3GPP TS 38.133 clause 8.3.2 (relating to single SCell activation). An additional implementation margin may be allowed for activation of multiple SCells as long as the requirement for activating multiple Scells is a significantly shorter time than the sum of SCell activation delay requirement in 3GPP TS 38.133 clause 8.3.2 (relating to single SCell activation) for activating each Scell sequentially.

According to embodiments that apply the sequential activation techniques described above, such embodiments may be carried out starting with a known SCell, if any, in order to prevent the UEs performing beam sweeping (cell identification of unknown SCell) when there already is knowledge of applicable spatial and temporal constraints.

Although the invention is described above in the context of SCell activation of configured but deactivated SCells, the described embodiments can also be applied for so called Direct SCell activation, whereby multiple SCells are directly activated upon SCell addition (via RRC reconfiguration) or upon handover or PSCell change (via RRC reconfiguration). In Direct SCell activation, the UE does not wait for a MAC SCell activation command when the SCell is added in activated state.

In Direct SCell activation, the SCell activation as described above is started when the UE has finished the RRC processing for the SCell addition, or when the UE has completed the handover or PSCell change procedure (random access towards PCell or PSCell).

The invention also described, at times, in the context of usage of specific synchronization signals (e.g., PSS and SSS in SSB). The solutions described may however be applied to any signal whose contents, and time and frequency allocation with respect to the frame timing in the cell, is known by the UE. Examples of such signals are CSI-RS, Temporary Reference Signals (TRS), Phase Tracking Reference Signals (PTRS), and/or DM-RS.

It should be further noted that a UE 50 as described above may perform any of the processing described herein by implementing any functional means or units. In one embodiment, for example, the UE 50 comprises respective circuits configured to perform the steps shown in FIG. 6 (and/or other Figures described above). The circuits in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory may store program code that, when executed by the one or more microprocessors, carries out the techniques described herein. That is, in some embodiments memory of the UE 50 contains instructions executable by processing circuitry whereby the UE 50 is configured to carry out the processing herein.

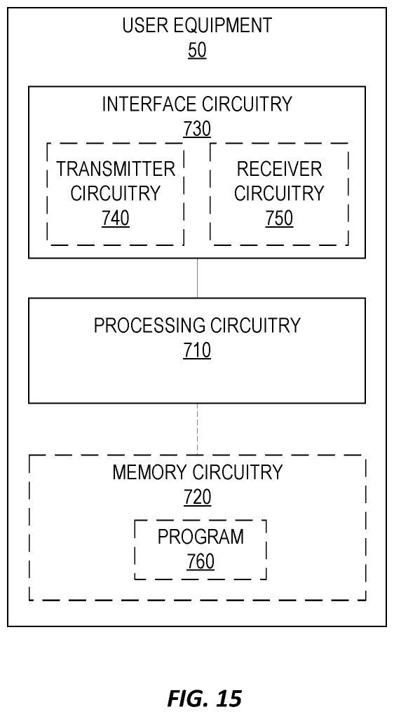

FIG. 15 illustrates additional details of a UE 50 in accordance with one or more embodiments. The UE 50 comprises processing circuitry 710 and interface circuitry 730. The processing circuitry 710 is communicatively coupled to the interface circuitry 730, e.g., via one or more buses. In some embodiments, the UE 50 further comprises memory circuitry 720 that is communicatively coupled to the processing circuitry 710, e.g., via one or more buses. According to particular embodiments, the processing circuitry 710 is configured to perform one or more of the methods described herein (e.g., the method 300 illustrated in FIG. 6).

The processing circuitry 710 of the UE 50 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions of a computer program 760 stored in memory circuitry 720 whereby the processing circuitry 710 is configured. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the UE 50. Such I/O data paths may include data paths for exchanging signals over a communications network, data paths for exchanging signals with a user, and/or data paths for exchanging data internally among components of the UE 50. For example, the interface circuitry 730 may comprise a transceiver configured to send and receive communication signals over one or more of a cellular network, Ethernet network, or optical network. The interface circuitry 730 may be implemented as a unitary physical component, or as a plurality of physical components that are contiguously or separately arranged, any of which may be communicatively coupled to any other, or may communicate with any other via the processing circuitry 710. For example, the interface circuitry 730 may comprise transmitter circuitry 740 configured to send communication signals over a communications network and receiver circuitry 750 configured to receive communication signals over the communications network. Other embodiments may include other permutations and/or arrangements of the above and/or their equivalents.

According to embodiments of the UE 50 illustrated in FIG. 15, the processing circuitry 710 is configured to receive, from a base station, a signal to activate a plurality of SCells, and responsive to receiving the signal, use a temporal characteristic and a spatial characteristic of a reference cell, selected from the plurality of SCells, to activate the reference cell and at least one other of the SCells in parallel.

Other embodiments of the present disclosure include corresponding computer programs. In one such embodiment, the computer program comprises instructions which, when executed on processing circuitry 730 of a UE 50, cause the UE 50 to carry out any of the UE processing described above. A computer program in either regard may comprise one or more code modules corresponding to the means or units described above.

Embodiments further include a computer program product comprising program code portions for performing the steps of any of the embodiments herein when the computer program product is executed by a computing device. This computer program product may be stored on a computer readable recording medium.

Embodiments further include a carrier containing such a computer program. This carrier may comprise one of an electronic signal, optical signal, radio signal, or computer readable storage medium.

Other embodiments will now be described with respect to certain contexts. These embodiments are combinable with and expound upon embodiments above.

Those skilled in the art will appreciate that the various methods and processes described herein may be implemented using various hardware configurations that generally, but not necessarily, include the use of one or more microprocessors, microcontrollers, digital signal processors, or the like, coupled to memory storing software instructions or data for carrying out the techniques described herein. In particular, those skilled in the art will appreciate that the circuitry of various embodiments may be configured in ways that vary in certain details from the broad descriptions given above. For instance, one or more of the processing functionalities discussed above may be implemented using dedicated hardware, rather than a microprocessor configured with program instructions. Such variations, and the engineering tradeoffs associated with each, will be readily appreciated by the skilled practitioner. Since the design and cost tradeoffs for the various hardware approaches, which may depend on system-level requirements that are outside the scope of the present disclosure, are well known to those of ordinary skill in the art, further details of specific hardware implementations are not provided herein.

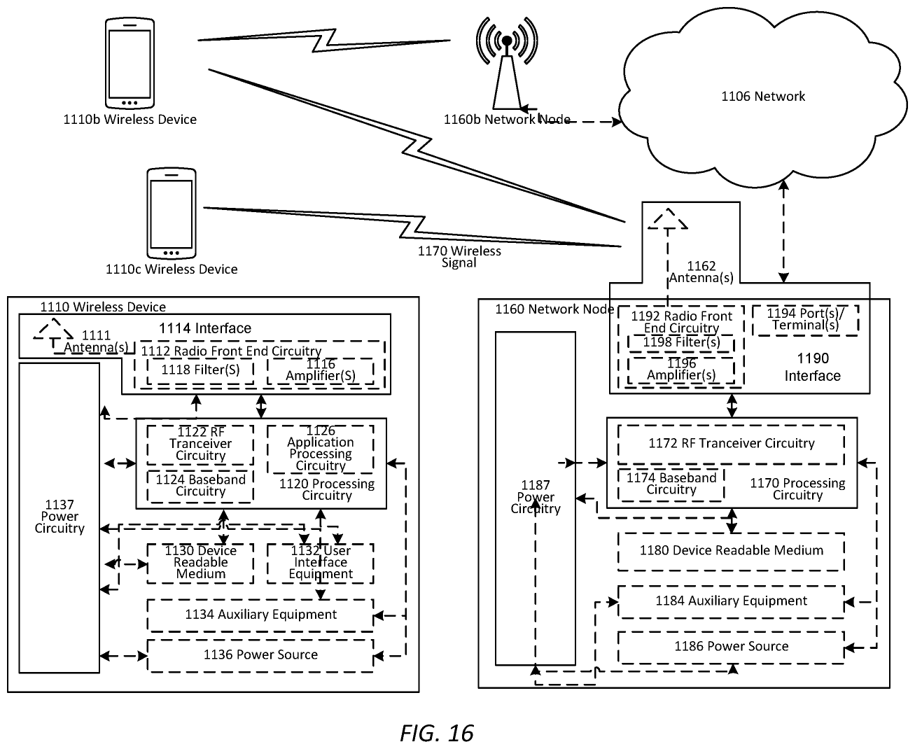

Although the subject matter described herein may be implemented in any appropriate type of system using any suitable components, the embodiments disclosed herein are described in relation to a wireless network, such as the example wireless network illustrated in FIG. 16. For simplicity, the wireless network of FIG. 16 only depicts network 1106, network nodes 1160 and 1160b, and wireless devices (WDs) 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and WD 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), UMTS, LTE, Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 16, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 16 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple RATs. In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, RF transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 16 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, a WD refers to a device capable, configured, arranged and/or operable to communicate wirelessly with network nodes and/or other wireless devices. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a M2M device, which may in a 3GPP context be referred to as an MTC device. As one particular example, the WD may be a UE implementing the 3GPP NB-IoT standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., RAM or ROM), mass storage media (e.g., a hard disk), removable storage media (e.g., a CD or DVD), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

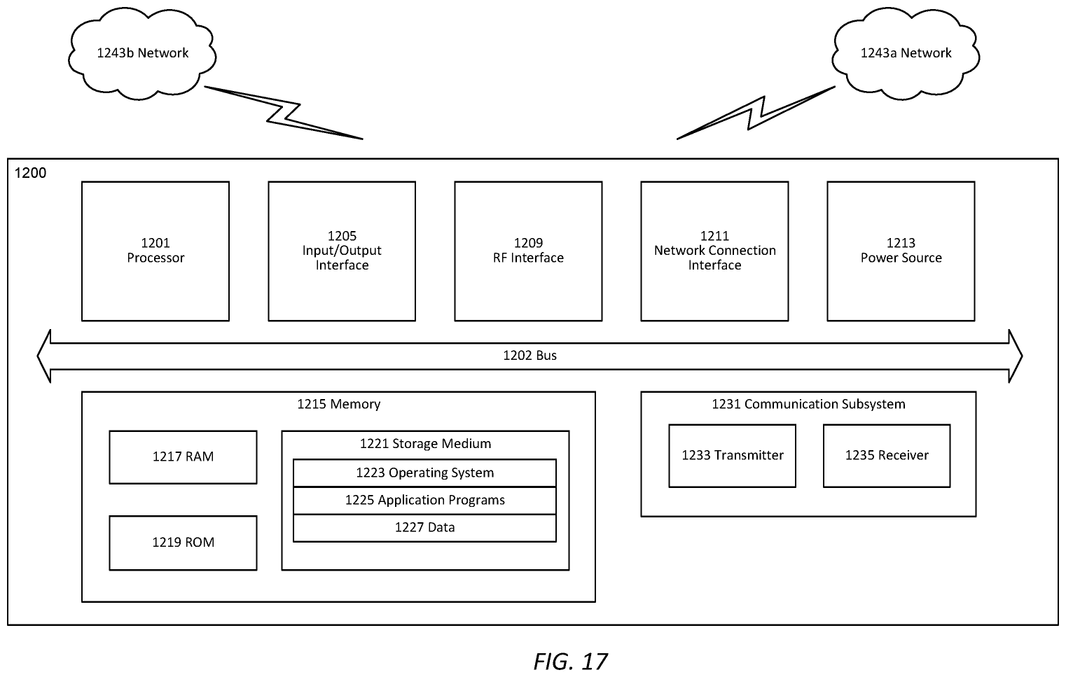

FIG. 17 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3GPP, including a NB-IoT UE, a MTC UE, and/or an enhanced MTC (eMTC) UE. UE 1200, as illustrated in FIG. 17, is one example of a WD configured for communication in accordance with one or more communication standards promulgated by the 3GPP, such as 3GPP's GSM, UMTS, LTE, and/or 5G standards. As mentioned previously, the term WD and UE may be used interchangeable. Accordingly, although FIG. 17 is a UE, the components discussed herein are equally applicable to a WD, and vice-versa.

In FIG. 17, UE 1200 includes processing circuitry 1201 that is operatively coupled to input/output interface 1205, RF interface 1209, network connection interface 1211, memory 1215 including RAM 1217, ROM 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 17, or only a subset of the components. The level of integration between the components may vary from one UE to another UE. Further, certain UEs may contain multiple instances of a component, such as multiple processors, memories, transceivers, transmitters, receivers, etc.

In FIG. 17, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or DSP, together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 17, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a LAN, a WAN, a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module (SIM) or a removable user identity module (RUIM), other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 17, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a LAN, a WAN, a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

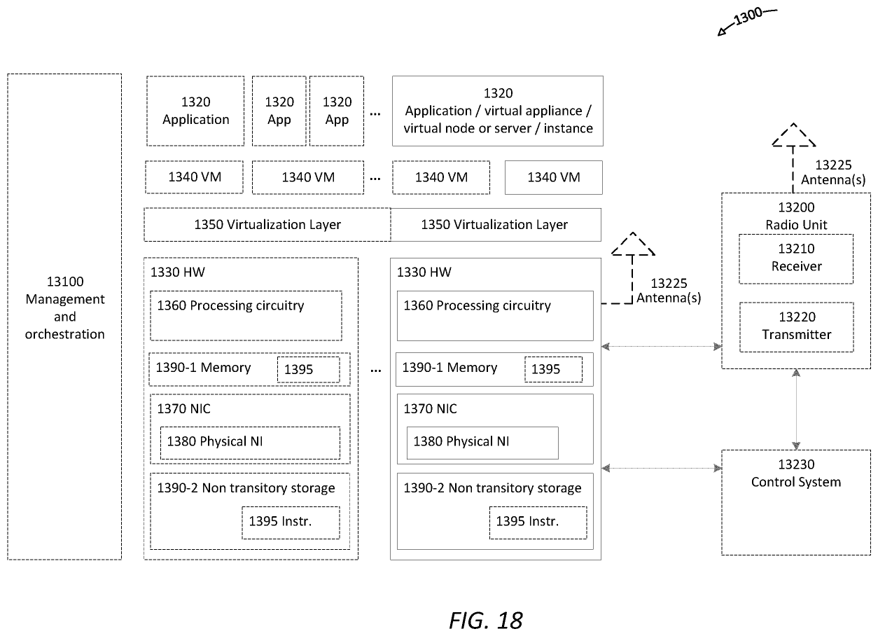

FIG. 18 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated ASICs, or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 18, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 18.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

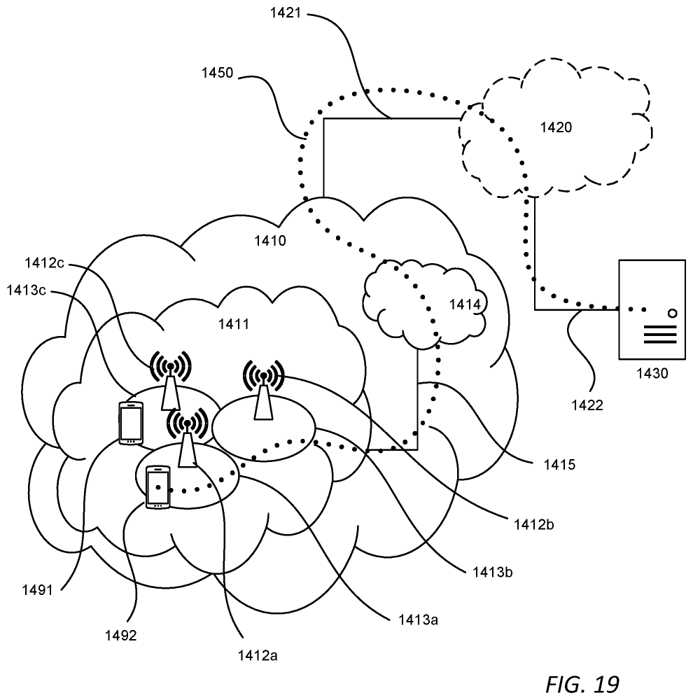

FIG. 19 illustrates a telecommunication network connected via an intermediate network to a host computer in accordance with some embodiments. In particular, with reference to FIG. 19, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 19 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

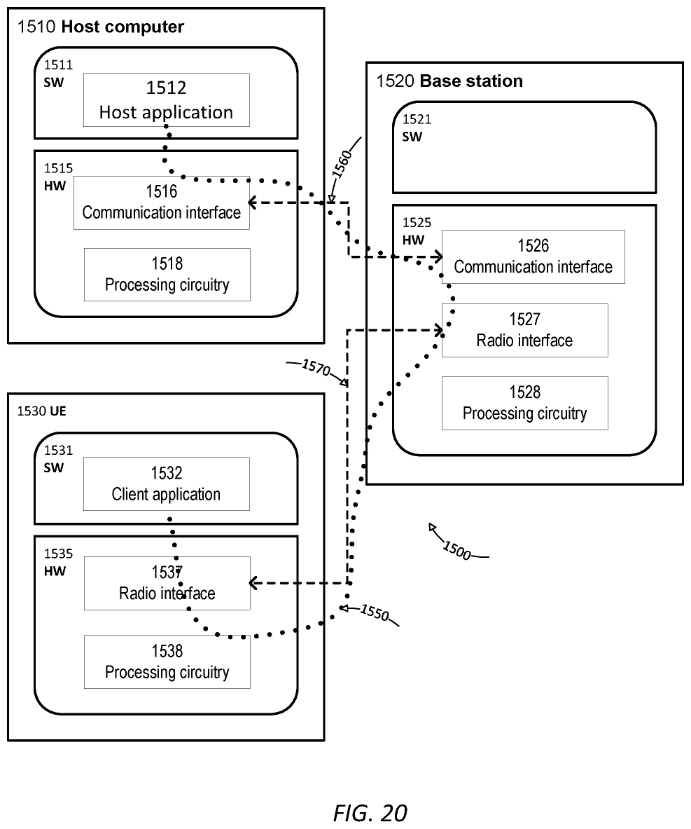

Example implementations, in accordance with an embodiment, of the UE, base station and host computer discussed in the preceding paragraphs will now be described with reference to FIG. 20. FIG. 20 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 20) served by base station 1520. Communication interface 1526 may be configured to facilitate connection 1560 to host computer 1510. Connection 1560 may be direct or it may pass through a core network (not shown in FIG. 20) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 20 may be similar or identical to host computer 1430, one of base stations 1412a, 1412b, 1412c and one of UEs 1491, 1492 of FIG. 19, respectively. This is to say, the inner workings of these entities may be as shown in FIG. 20 and independently, the surrounding network topology may be that of FIG. 19.

In FIG. 20, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve service continuity and thereby provide benefits such as the ability to activate secondary cells more quickly without increasing UE complexity.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

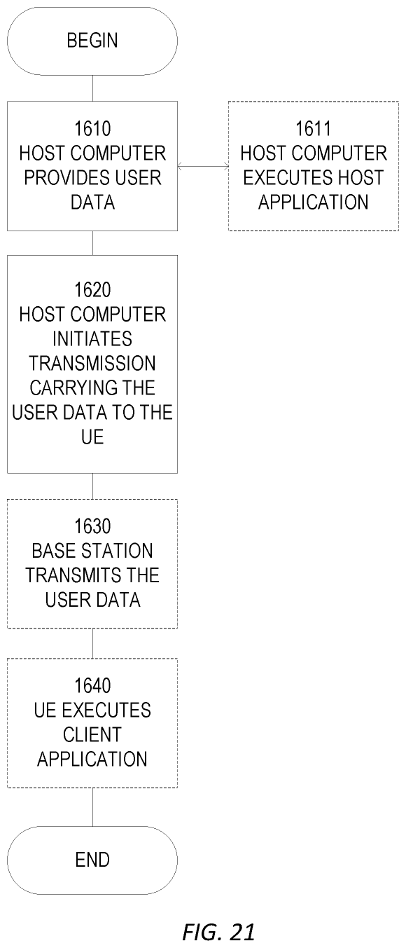

FIG. 21 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 21 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

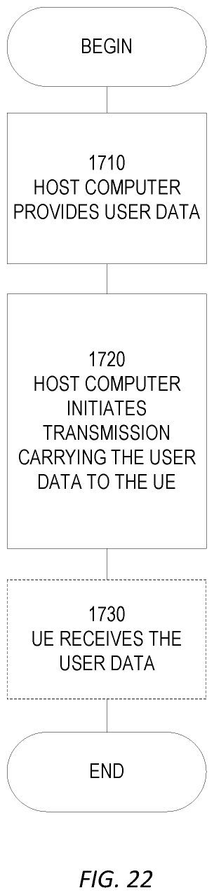

FIG. 22 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 22 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

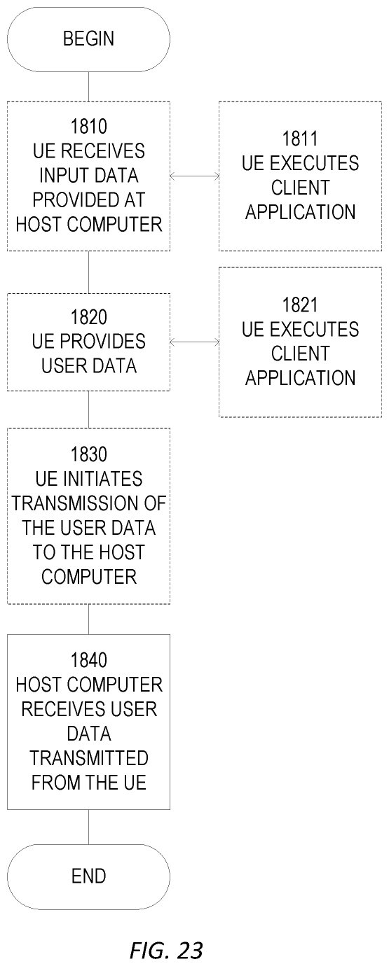

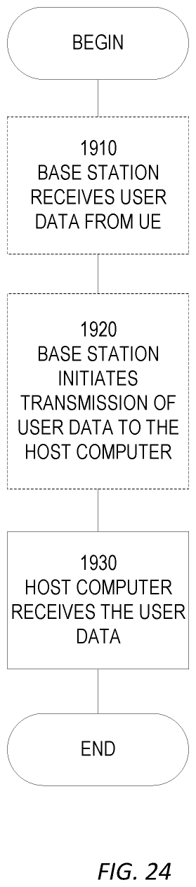

FIG. 23 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 23 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 23 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. The disclosed subject matter should not be construed as limited to only the embodiments set forth herein; rather, these embodiments are provided by way of example to convey the scope of the subject matter to those skilled in the art.

The present embodiments may, of course, be carried out in other ways than those specifically set forth herein without departing from essential characteristics of the invention. The present embodiments are to be considered in all respects as illustrative and not restrictive, and all changes coming within the meaning and equivalency range of the appended enumerated embodiments are intended to be embraced therein.

Any abbreviations used herein should be interpreted with reference to the following, unless otherwise defined above:
3GPP: Third Generation Partnership Project
AGC: Automatic Gain Control
ATC: Automatic Timing Control
BS: Base Station
BSC: Base Station Controller
BTS: Base Transceiver Station
CA: Carrier Aggregation
CD: Compact Disk
COTS: Commercial Off-the-Shelf
CPE: Customer-Premise Equipment
CPU: Central Processing Unit
CQI: Channel Quality Indicator
CSI: Channel State Information
CSI-RS: Channel State Information Reference Signal
CSSF: Carrier Specific Scaling Factor
D2D: Device-to-Device
DAS: Distributed Antenna System
DC: Direct Current
DCI: Downlink Control Information
DIMM: Dual Inline Memory Module
DM-RS: Demodulation Reference Signals
DRX: Discontinuous Reception
DSPs: Digital Signal Processors
DVD: Digital Video Disk
EEPROM: Electrically Erasable Programmable Read-Only Memory
eNB: Evolved Node B
EPROM: Erasable Programmable Read-Only Memory
EUTRAN: Evolved UMTS Terrestrial RAN
FDD: Frequency Division Duplex
FFT: Fast Fourier Transform
FPGA: Field-Programmable Gate Array
FR: Frequency Range
FR1: Frequency Range 1
FR2: Frequency Range 2
gNB: NR NodeB
GPS: Global Positioning System
GSM: Global System for Mobile Communications
HDDS: Holographic Digital Data Storage
HD-DVD: High-Density Digital Versatile Disc
I/O: Input/Output
IoT: Internet of Things
L1-RSRP: Layer 1 Reference Signal Received Power
LAN: Local Area Network
LEE: Laptop-Embedded Equipment
LME: Laptop-Mounted Equipment
LTE: Long Term Evolution
M2M: Machine-to-Machine
MAC: Media Access Control
MANO: Management and Orchestration
MBSFN: Multimedia Broadcast Single Frequency Network
MCE: Multi-cell/Multicast Coordination Entity
MIB: Master Information Block
MRTD: Maximum Receive Time Difference
MSR: Multi-Standard Radio
MTC: Machine Type Communication
NB-IoT: Narrowband Internet of Things
NFV: Network Function Virtualization
NIC: Network Interface Controller
NR: New Radio
OFDM: Orthogonal Frequency Division Multiplexing
OTT: Over-the-Top
PBCH: Physical Broadcast Channel
PCell: Primary Cell
PDA: Personal Digital Assistant
PDCCH: Physical Downlink Control Channel
PDP: Power Delay Profile
PDSCH: Physical Downlink Shared Channel
PROM: Programmable Read-Only Memory
PSCell: Primary Secondary Cell
PSS: Primary Synchronization Signal
PSTN: Public Switched Telephone Network
PTRS: Phase Tracking Reference Signals
RAID: Redundant Array of Independent Disks
RAM: Random Access Memory
RAN: Radio Access Network
RF: Radio Frequency
RNC: Radio Network Controller
ROM: Read-Only Memory
RRC: Radio Resource Control
RRH: Remote Radio Head
RRU: Remote Radio Unit
RS: Reference Signal
RSRP: Reference Signal Received Power
RSRQ: Reference Signal Received Quality
RUIM: Removable User Identity Module
Rx: Receive
SCell: Secondary Cell
SCS: Subcarrier Spacing
SD: Secure Digital
SDRAM: Synchronous Dynamic Random Access Memory
SIM: Subscriber Identity Module
SINR: Signal-to-Interference-plus-Noise Ratio
SMTC: SSB measurement time configuration
SOC: System on a Chip
SS: Synchronization Signal
SSB: Synchronization Signal and Physical Broadcast Channel Block
SS-RSRP: Synchronization Signal Reference Signal Received Power
SS-RSRQ: Synchronization Signal Reference Signal Received Quality
SSS: Secondary Synchronization Signal
SS-SINR: Synchronization Signal Signal-to-Interference-plus-Noise Ratio
TCI: Transmission Configuration Indication
TRS: Temporary Reference Signals
Tx: Transmission
UE: User Equipment
UMTS: Universal Mobile Telecommunications Service
V2I: Vehicle-to-Infrastructure
V2V: Vehicle-to-Vehicle
V2X: Vehicle-to-Everything
VMM: Virtual Machine Monitor
VNE: Virtual Network Elements
VNF: Virtual Network Function
VoIP: Voice over IP
WAN: Wide-Area Networks
WD: Wireless Device
WiMax: Worldwide Interoperability for Microwave Access
WLAN: Wireless Local Area Network

1. A method of parallel secondary cell, SCell, activation,
implemented by a User Equipment, UE, in a wireless communication network, the method comprising:
receiving, from a network node, a signal to activate a plurality of SCells; and
responsive to receiving the signal, using a temporal characteristic and a spatial characteristic of a reference cell, selected from the plurality of SCells, to activate the reference cell and at least one other of the SCells in parallel.

2. The method of claim 1, wherein using the spatial characteristic of the reference cell comprises using a receiving beam steered in a same direction suitable for receiving the reference cell to monitor for a synchronization signal of the at least one other of the SCells being activated in parallel.

3. The method of claim 1, wherein using the temporal characteristic of the reference cell comprises, locating a frame timing of the other of the SCells being activated in parallel based on a threshold uncertainty interval relative to a timing of the reference cell.

4. The method of claim 1, further comprising selecting the reference cell from the plurality of SCells based on the reference cell having a cell condition that is known to the UE.

5. The method of claim 1, further comprising selecting the reference cell from the plurality of SCells based on the reference cell being configured with Layer 1 Reference Signal Receive Power, L1-RSRP, reporting and an active Transmission Configuration Indication, TCI, state not being provided at the time of receiving the signal to activate the plurality of SCells.

6. The method of claim 1, further comprising selecting the reference cell from the plurality of SCells based on a Synchronization Signal and Physical Broadcast Channel Block, SSB, measurement time configuration, SMTC, period.

7. The method of claim 1, further comprising selecting the reference cell from the plurality of SCells based on an order of the plurality of SCells indicated by the signal to activate the plurality of SCells.

8. The method of claim 1, further comprising selecting the reference cell from the plurality of SCells based on a measurement cycle length.

9. The method of claim 1, further comprising selecting the reference cell from the plurality of SCells based on a discontinuous reception, DRX, cycle length.

10. The method of claim 1, further comprising selecting the reference cell from the plurality of SCells based on a Carrier Specific Scaling Factor, CSSF.

11. The method of claim 1, further comprising selecting the reference cell from the plurality of SCells based on a cell detection duration.

12. The method of claim 1, further comprising receiving an indication from the network node of which of the plurality of SCells to use as the reference cell, and selecting the SCell indicated by the network node as the reference cell in response.

13. The method of claim 1, further comprising using an SSB of the reference cell to activate the SCells in parallel.

14. The method of claim 1, further comprising verifying successful reception of the SCells activated in parallel.

15. The method of claim 14, wherein verifying successful reception of the SCells activated in parallel comprises verifying that a secondary synchronization signal received in a synchronization signal block matches an expected physical cell ID of at least one of the SCells activated in parallel.

16. The method of claim 14, wherein verifying successful reception of the SCells activated in parallel comprises measuring Synchronization Signal Reference Signal Received Power, SS-RSRP, of an SCell using a single measurement or a plurality of abbreviated measurements, and determining that the SS-RSRP is above a threshold.

17. The method of claim 14, wherein verifying successful reception of the SCells activated in parallel comprises measuring L1-RSRP of an SSB for an SCell and determining that the L1-RSRP is above a threshold.

18. The method of claim 15, wherein verifying successful reception of the at least one of the SCells activated in parallel comprises measuring L1-RSRP of a Channel State Information Reference Signal, CSI-RS, for an SCell and determining that the L1-RSRP is above a threshold.

19. (canceled)

20. The method of claim 1, further comprising:
assigning each of the plurality of SCells to either a first activation group or a second activation group;
commencing activation of each of the SCells in the first activation group before commencing activation of each of the SCells in the second activation group.

21. The method of claim 20, wherein commencing activation of each of the SCells in the first activation group before commencing activation of each of the SCells in the second activation group comprises commencing activation of each of the SCells in the second activation group:
before all of the SCells in the first activation group have completed activation; and
responsive to determining, for each of the SCells in the first activation group, a receiving beam, frame timing, and TCI state.

22-25. (canceled)

26. The method of claim 1, further comprising:
locating respective synchronization signals for at least two additional SCells based on respective Synchronization Signal and Physical Broadcast Channel Blocks, SSBs, received from the network node in a same SSB burst; and
activating the at least two additional SCells in parallel within a first frequency range using the synchronization signals located based on the respective SSBs;
wherein using the temporal characteristic and the spatial characteristic of the reference cell to activate the SCells in parallel comprises activating the SCells in parallel within a second frequency range disjoint from the first frequency range.

27. The method of claim 1, further comprising:
activating, from a set of the SCells, a maximum number of SCells the UE is capable of activating in parallel; and
activating a set of remainder SCells from the set of SCells after activating the maximum number of SCells in the set.

28. A User Equipment, UE, in a wireless communication network, the UE configured to:
receive, from a network node, a signal to activate a plurality of secondary cells, SCells; and
responsive to receiving the signal, use a temporal characteristic and a spatial characteristic of a reference cell, selected from the plurality of SCells, to activate the reference cell and at least one other of the SCells in parallel.

29. The UE of claim 28, further configured to perform a method of parallel secondary cell, SCell, activation, implemented by a User Equipment, UE, in a wireless communication network, the method comprising:
receiving, from a network node, a signal to activate a plurality of SCells; and
responsive to receiving the signal, using a temporal characteristic and a spatial characteristic of a reference cell, selected from the plurality of SCells, to activate the reference cell and at least one other of the SCells in parallel,
wherein using the spatial characteristic of the reference cell comprises using a receiving beam steered in a same direction suitable for receiving the reference cell to monitor for a synchronization signal of the at least one other of the SCells being activated in parallel.

30. A User Equipment, UE, in a wireless communication network, the UE comprising:
a processor and a memory, the memory containing instructions executable by the processor whereby the UE is operative to:
receive, from a network node, a signal to activate a plurality of secondary cells, SCells; and
responsive to receiving the signal, use a temporal characteristic and a spatial characteristic of a reference cell, selected from the plurality of SCells, to activate the reference cell and at least one other of the SCells in parallel.

31. The UE of claim 30, whereby the UE is further operative to perform a method of parallel secondary cell, SCell, activation, implemented by a User Equipment, UE, in a wireless communication network, the method comprising:
receiving, from a network node, a signal to activate a plurality of SCells; and
responsive to receiving the signal, using a temporal characteristic and a spatial characteristic of a reference cell, selected from the plurality of SCells, to activate the reference cell and at least one other of the SCells in parallel,
wherein using the spatial characteristic of the reference cell comprises using a receiving beam steered in a same direction suitable for receiving the reference cell to monitor for a synchronization signal of the at least one other of the SCells being activated in parallel.

32-33. (canceled)
